(19) United States
(12) Patent Application Publication
(10) Pub. No.: US 2025/0056257 A1
(43) Pub. Date: Feb. 13, 2025

(54) METHODS FOR WIRELESS COMMUNICATION, NETWORK DEVICES AND TERMINAL DEVICES

(71) Applicant: GUANGDONG OPPO MOBILE TELECOMMUNICATIONS CORP., LTD., Dongguan (CN)

(72) Inventors: Jianfei CAO, Dongguan (CN); Wendong LIU, Dongguan (CN); Wenhong CHEN, Dongguan (CN); Zhihua SHI, Dongguan (CN)

(21) Appl. No.: 18/925,732

(22) Filed: Oct. 24, 2024

Related U.S. Application Data
(63) Continuation of application No. PCT/CN2022/089649, filed on Apr. 27, 2022.

(51) Int. Cl. H04W 24/02; H04W 16/28

(52) U.S. Cl. CPC H04W 24/02; H04W 16/28

(57) ABSTRACT

Provided is a method for wireless communication, applicable to a network device, the method includes: acquiring a first data set, wherein the first data set includes at least one of identification information of M1 spatial filters or measurement results of the M1 spatial filters, M1 being a positive integer; and inputting the first data set into a target model to output target information, wherein the target information includes at least one of identification information of K spatial filters or measurement results of the K spatial filters, K being a positive integer.

### CROSS-REFERENCE TO RELATED APPLICATION

This application is a continuation of International Application No. PCT/CN2022/089649, filed Apr. 27, 2022, the entire disclosure of which is incorporated herein by reference.

### TECHNICAL FIELD

Embodiments of the present disclosure relate to the field of communications, and in particular to methods for wireless communication, network devices, and terminal devices.

### BACKGROUND

In a new radio (NR) system, communication in a millimeter-wave frequency band as well as corresponding beam management mechanism is introduced, including beam management which can be divided into uplink beam management and downlink beam management. The downlink beam management includes downlink beam scanning, optimal beam reporting at a terminal side, downlink beam indication at a network side, and other processes. Specifically, a network device scans all transmission (Tx) beam directions over downlink reference signals. A terminal device uses different reception (Rx) beams for measurement, such that all beam pairs are traversed.

The terminal device selects optimal beams by traversing all combinations of Tx beams and Rx beams, resulting in a lot of overhead and delay.

### SUMMARY

The present disclosure provides methods for wireless communication, network devices, and terminal devices.

According to some embodiments, a method for wireless communication is provided. The method includes: acquiring a first data set by a network device, where the first data set includes identification information of M1 spatial filters and/or measurement results of the M1 spatial filters, M1 being a positive integer; and
inputting the first data set into a target model to output target information, where the target information includes at least one of identification information of K spatial filters or measurement results of the K spatial filters, K being a positive integer.

According to some embodiments, a method for wireless communication is provided. The method includes: acquiring a third data set by a terminal device, where the third data set includes at least one of identification information of M3 spatial filters or measurement results of the M3 spatial filters, M3 being a positive integer; and
inputting the third data set into a target model to output target information, where the target information includes at least one of identification information of K spatial filters or measurement results of the K spatial filters, K being a positive integer.

According to some embodiments, a method for wireless communication is provided. The method includes: acquiring a sixth data set by a network device, where the sixth data set includes measurement information of a plurality of spatial filters by a terminal device; and acquiring model parameters of the target model by training a target model based on the sixth data set, where the target model is used to determine a target spatial filter in the plurality of spatial filters based on measurement results of the plurality of spatial filters.

According to some embodiments, a network device is provided. The network device includes a processor and a memory configured to store one or more computer programs, and the processor, when loading and running the one or more computer programs stored in the memory, is caused to perform the method as defined in the embodiments above.

According to some embodiments, a terminal device is provided. The terminal device includes a processor and a memory configured to store one or more computer programs, and the processor, when loading and running the one or more computer programs stored in the memory, is caused to perform the method as defined in the embodiments above.

### BRIEF DESCRIPTION OF THE DRAWINGS

FIG. 1 is a schematic diagram of a communication system architecture according to some embodiments of the present disclosure.

FIG. 2 is a schematic diagram of the connection of neurons in a neural network.

FIG. 3 is a schematic structural diagram of a convolutional neural network.

FIG. 4 is a schematic structural diagram of a long short-term memory (LSTM) unit.

FIG. 5 is a schematic diagram of a downlink beam scanning process.

FIG. 6 is a schematic diagram of another downlink beam scanning process.

FIG. 7 is a schematic diagram of a method for wireless communication according to some embodiments of the present disclosure.

FIG. 8 is a schematic constitutional diagram of a target model.

FIG. 9 is a schematic diagram of a model structure and a relationship between the input and output of a first target model according to some embodiments of the present disclosure.

FIG. 10 is a schematic diagram of a model structure and a relationship between the input and output of a second target model according to some embodiments of the present disclosure.

FIG. 11 is a schematic diagram of another method for wireless communication according to some embodiments of the present disclosure.

FIG. 12 is a schematic diagram of still another method for wireless communication according to some embodiments of the present disclosure.

FIG. 13 is a schematic diagram of still another method for wireless communication according to some embodiments of the present disclosure.

FIG. 14 is a schematic interaction diagram in which model training and inference are performed at a network device side.

FIG. 15 is a schematic interaction diagram in which model training is performed at a network device side and inference is performed at a terminal device side.

FIG. 16 is a schematic interaction diagram in which model training is performed at a network device side and inference is performed at both a terminal device side and the network device side.

FIG. 17 is a schematic interaction diagram in which model training and inference are performed at a terminal device side.

FIG. 18 is a schematic interaction diagram in which model training is performed at a terminal device side and inference is performed at both the terminal device side and a network device side.

FIG. 19 is a schematic interaction diagram in which model training is performed at a terminal device side and inference is performed at a network device side.

FIG. 20 is a schematic block diagram of a network device according to some embodiments of the present disclosure.

FIG. 21 is a schematic block diagram of a terminal device according to some embodiments of the present disclosure.

FIG. 22 is a schematic block diagram of another network device according to some embodiments of the present disclosure.

FIG. 23 is a schematic block diagram of another terminal device according to some embodiments of the present disclosure.

FIG. 24 is a schematic block diagram of a communication device according to some embodiments of the present disclosure.

FIG. 25 is a schematic block diagram of a chip according to some embodiments of the present disclosure.

FIG. 26 is a schematic block diagram of a communication system according to some embodiments of the present disclosure.

### DETAILED DESCRIPTION

The technical solutions in the embodiments of the present disclosure are described below with reference to the accompanying drawings in the embodiments of the present disclosure. It is apparent that the described embodiments are merely some rather than all of the embodiments of the present disclosure. All other embodiments acquired by a person of ordinary skill in the art based on the embodiments of the present disclosure without creative efforts shall fall within the protection scope of the present disclosure

The technical solutions in the embodiments of the present disclosure are applicable to various communication systems, such as a global system of mobile communications (GSM), a code division multiple access (CDMA) system, a wideband code division multiple access (WCDMA) system, a general packet radio system (GPRS), a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi) network, a 5G communication system, or another communication system.

Generally, a conventional communication system supports a limited quantity of connections and is easy to implement. However, with development of communication technologies, a mobile communication system supports device-to-device (D2D) communication, machine-to-machine (M2M) communication, machine-type communication (MTC), vehicle-to vehicle-(V2V) communication, vehicle-to-everything (V2X) communication, and the like in addition to conventional communication. The embodiments of the present disclosure are also applicable to these communication systems.

Optionally, the communication system in the embodiments of the present disclosure is applicable to a carrier aggregation (CA) scenario, a dual connectivity (DC) scenario, or a standalone (SA) networking scenario

Optionally, the communication system in the embodiments of the present disclosure is applicable to an unlicensed spectrum. The unlicensed spectrum is also considered as a shared spectrum. Alternatively, the communication system in the embodiments of the present disclosure is applicable to a licensed spectrum. The licensed spectrum is also considered as an unshared spectrum.

The embodiments of the present disclosure are described in conjunction with a network device and a terminal device, where the terminal device may also be referred to as a user equipment (UE), an access terminal, a subscriber unit, a subscriber station, a rover station, a mobile station, a remote station, a remote terminal, a mobile device, a user terminal, a terminal, a wireless communication device, a user agent, a user device, etc.

The terminal device is a station in a WLAN, or is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a next-generation communication system such as an NR network, a terminal device in a future evolved PLMN, or the like.

In the embodiments of the present disclosure, the terminal device is deployed on land, including indoor or outdoor, handheld, wearable, or vehicle-mounted, is deployed on water (such as a ship), or is deployed in the air (such as on an aircraft, a balloon, or a satellite).

In the embodiments of the present disclosure, the terminal device is a mobile phone, a tablet computer, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, or the like.

By way of example but not limitation, in the embodiments of the present disclosure, the terminal device is alternatively a wearable device. The wearable device is also referred to as a wearable intelligent device. Wearable technology is used to intelligently design daily wear and develop wearable devices, such as glasses, a glove, a watch, clothing, or shoes. The wearable device is a portable device that is directly worn or integrated into a user's clothing or accessory. The wearable device is not only a hardware device, but also implements powerful functions through software support, data interaction, and cloud interaction. Generalized wearable intelligent devices include full-function and large-size devices that can achieve a complete or partial function without relying on smartphones, such as smart watches or smart glasses, and devices that focus on a specific type of AF and need to be used with smartphones or the like, such as various smart bands or smart jewelry used for sign monitoring.

In some embodiments of the present disclosure, the network device is a device configured to communicate with a mobile device. The network device is an access point (AP) in a WLAN, a base transceiver station (BTS) in a GSM or CDMA system, a NodeB (NB) in a WCDMA system, an evolved NodeB (eNB or eNodeB) in an LTE system, a relay station or an AP, a vehicle-mounted device, a wearable device, a gNodeB (gNB) in an NR network, a network device in a future evolved public land mobile network (PLMN), a network device in an NTN network, or the like.

By way of example and not limitation, in the embodiments of the present disclosure, the network device has a mobile nature. For example, the network device is a mobile device. In some embodiments, the network device is a satellite, or a balloon station. For example, the satellite is a low earth orbit (LEO) satellite, a medium earth orbit (MEO) satellite, a geostationary earth orbit (GEO) satellite, a high elliptical orbit (HEO) satellite, etc. In some embodiments, the network device is a base station located on land, in water, etc.

In the embodiments of the present disclosure, the network device provides a service for a cell, and a terminal device communicates with the network device based on a transmission resource (e.g., a frequency domain resource or a frequency spectrum resource) used by the cell, where the cell is a cell corresponding to the network device (e.g., a base station), and the cell belongs to a macro base station or to a base station corresponding to a small cell, where the small cell includes: metro cells, micro cells, pico cells, femto cells, and the like, and the small cells have the characteristics of small coverage area and low transmission power, and are suitable for providing high-rate data transmission services.

Exemplarily, a communication system 100 applied in the embodiments of the present disclosure is illustrated in FIG. 1. The communication system 100 includes a network device 110, and the network device 110 is a device communicating with a terminal device 120 (or referred to as a communication terminal, or a terminal). The network device 110 provides communication coverage for a particular geographic region and communicates with terminal devices located within the coverage region.

FIG. 1 exemplarily shows one network device and two terminal devices. In some embodiments, the communication system 100 includes a plurality of network devices and other number of terminal devices within a coverage area of each of the network devices, which is not limited in the embodiments of the present disclosure.

In some embodiments, the communication system 100 further includes other network entities, such as a network controller, and a mobile management entity, which is not limited in the embodiments of the present disclosure.

It should be understood that a device having a communication function in the network/system in the embodiments of the present disclosure is referred to as a communication device. In the communication system 100 shown in FIG. 1, for example, the communication device includes a network device 110 and a terminal device 120 having a communication function, and the network device 110 and the terminal device 120 are devices that have been specifically described above, which are not repeated herein. The communication device further includes other devices in the communication system 100, such as other network entities, for example, a network controller, and a mobile management entity, which is not limited in the embodiments of the present disclosure.

It should be understood that the terms “system” and “network” in this specification can be exchanged. The term “and/or” in this specification merely describes an association relationship between associated objects, and indicates that three types of relationships exist. For example, A and/or B indicates that A exists alone, A and B coexist, or B exists alone. In addition, the character “/” in this specification generally indicates that the associated objects are in an “or” relationship.

It should be understood that the term “indication” mentioned in the embodiments of the present disclosure is a direct indication, an indirect indication, or an association relationship. For example, A indicates B, which means that A directly indicates B, for example, B is acquired from A; means that A indirectly indicates B, for example, A indicates C, and B is acquired from C; or means an association relationship between A and B.

In the description of the embodiments of the present disclosure, the term “corresponding” indicates a direct or indirect correspondence between two objects, an association relationship between the two objects, or a relationship between indication and being indicated, between configuration and being configured, or the like.

In the embodiments of the present disclosure, “predefinition” is implemented by pre-storing corresponding code or a corresponding table in a device (such as the terminal device or the network device) or through another method that can be used to indicate relevant information, and a specific implementation method thereof is not limited in the present disclosure. For example, a predefined thing is a thing defined in a protocol.

In the embodiments of the present disclosure, the “protocol” is a standard protocol in the communication field, for example, includes an LTE protocol, an NR protocol, and a related protocol applied in a future communication system. This is not limited in the present disclosure.

For facilitating a better understanding of the embodiments of the present disclosure, neural networks and machine learning involved in the present disclosure are described.

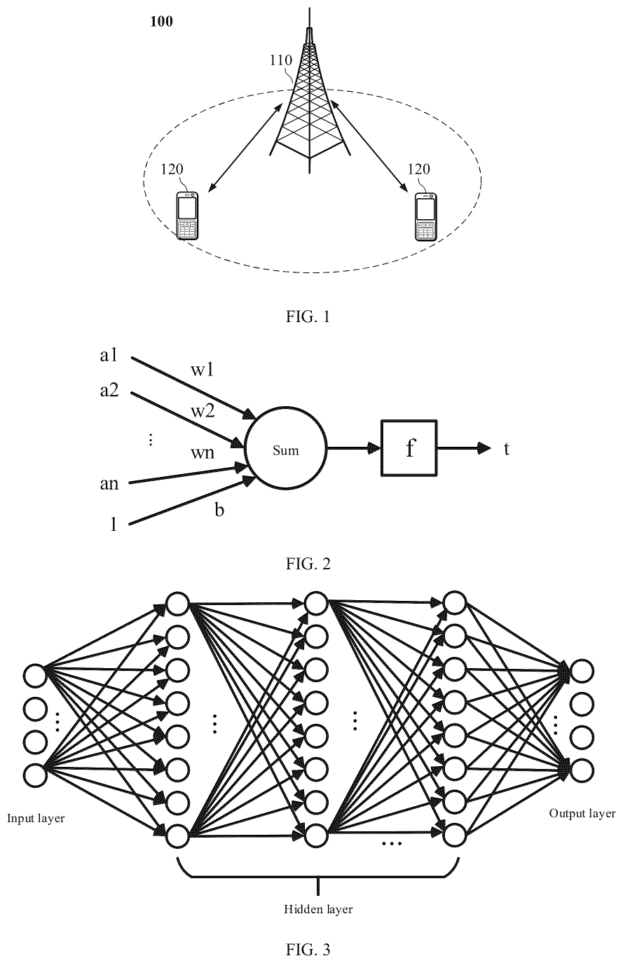

A neural network (NN) is an operational model formed by connecting a plurality of neuron nodes to each other, as shown in FIG. 2, where the connections between the nodes represent weighted values from input signals to output signals, which are referred to as weights; and each node performs weighted summation on different input signals and outputs a result through a specific activation function.

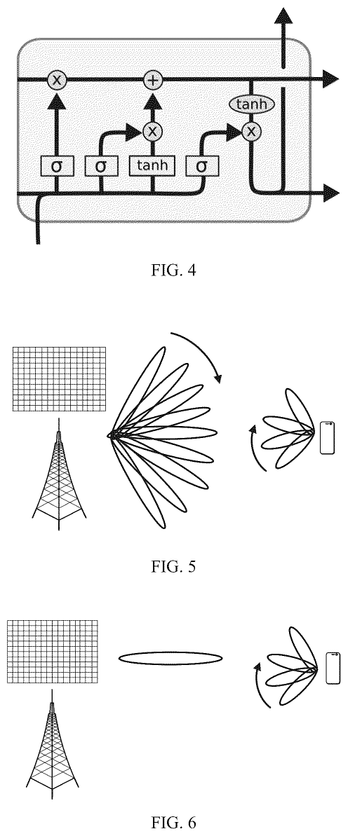

A convolutional neural network (CNN) is a typical neural network. FIG. 3 is a diagram of a simple CNN structure, which includes an input layer, hidden layers, and an output layer. Different outputs can be generated through different connection modes of the plurality of neurons, weights, and activation functions, such that a mapping relationship is fitted from the input to the output, where each upper-level node is connected to all lower-level nodes thereof.

A recurrent neural network (RNN) is a neural network that models sequential data, which has made remarkable achievements in the field of natural language processing, such as machine translation and speech recognition. Specifically, the network device memorizes information of previous occasions and uses the information in the calculation of a current output, i.e., the nodes between the hidden layers are no longer unconnected but connected, and an input of a hidden layer includes not only the input layer but also an output of a hidden layer at a last occasion. Commonly used RNNs include long short-term memory (LSTM) networks and gated recurrent units (GRUs). FIG. 4 shows a basic LSTM cell structure, which may include a tan h activation function. Unlike the RNN which only considers the most recent state, cell states of the LSTM determine which states should be kept and which states should be discarded, which solves defects of long-term memory in the conventional RNN.

For facilitating a better understanding of the embodiments of the present disclosure, beam management involved in the present disclosure is described.

In an NR system, communication in a millimeter-wave frequency band is introduced, and a corresponding beam management mechanism is also introduced, including beam management which can be divided into uplink beam management and downlink beam management. The downlink beam management includes downlink beam scanning, optimal beam reporting at the UE side, downlink beam indication at the network side, and other processes.

The downlink beam scanning process refers to that the network device scans different Tx beam directions over downlink reference signals. The UE uses different Rx beams for measurement, such that all beam pairs is traversed, and the UE calculates a corresponding layer-1 reference signal received power (L1-RSRP) value for each beam pair.

The downlink reference signal includes a synchronization signal block (SSB) and/or a channel state information reference signal (CSI-RS).

The downlink beam scanning process includes a P1 process shown in FIG. 5 (or referred to as a downlink full scanning process) and a P3 process shown in FIG. 6.

As shown in FIG. 5, the network device traverses all the Tx beams to transmit the downlink reference signals, and the UE traverses all the Rx beams for measurement to determine corresponding measurement results.

As shown in FIG. 6, the network device transmits the downlink reference signal with a specific Tx beam, and the UE traverses all the Rx beams for measurement to determine corresponding measurement results.

After the network device acknowledges optimal beams reported by the terminal device, a transmission configuration indicator (TCI) state (including a Tx beam using a downlink reference signal as a reference) is carried over media access control (MAC) or downlink control information (DCI) signaling to complete beam indication for the UE, and the UE uses an Rx beam corresponding to the Tx beam for downlink reception.

For the downlink full scanning process, i.e., the P1 process, the UE needs to traverse all combinations of Tx beams and Rx beams, which brings a lot of overhead and delay. For example, the network device deploys 64 different downlink Tx beams (which are carried by at most 64 SSBs) in an FR2 frequency band. In reception of the UE, the UE uses a plurality of antenna panels (including only one Rx beam panel) to scan the Rx beams simultaneously. Each of the antenna panels has four Rx beams, and then the UE needs to measure at least 256 beam pairs, which requires a downlink resource overhead of 256 resources.

From a time perspective, each SSB period is approximately 20 ms, and then four SSB periods are required to complete the measurement of four Rx beams (assuming that a plurality of Rx antenna panels can scan through the beams), such that at least 80 ms is required.

Therefore, how to reduce the overhead and delay of beam selection is an urgent problem to be solved.

For facilitating understanding of the technical solutions of the embodiments of the present disclosure, the technical solutions of the present disclosure are described in detail below with specific embodiments. As an alternative, the following related technologies may be combined with the technical solutions of the embodiments of the present disclosure in any manner, all of which fall within the protection scope of the embodiments of the present disclosure. The embodiments of the present disclosure include at least part of the following.

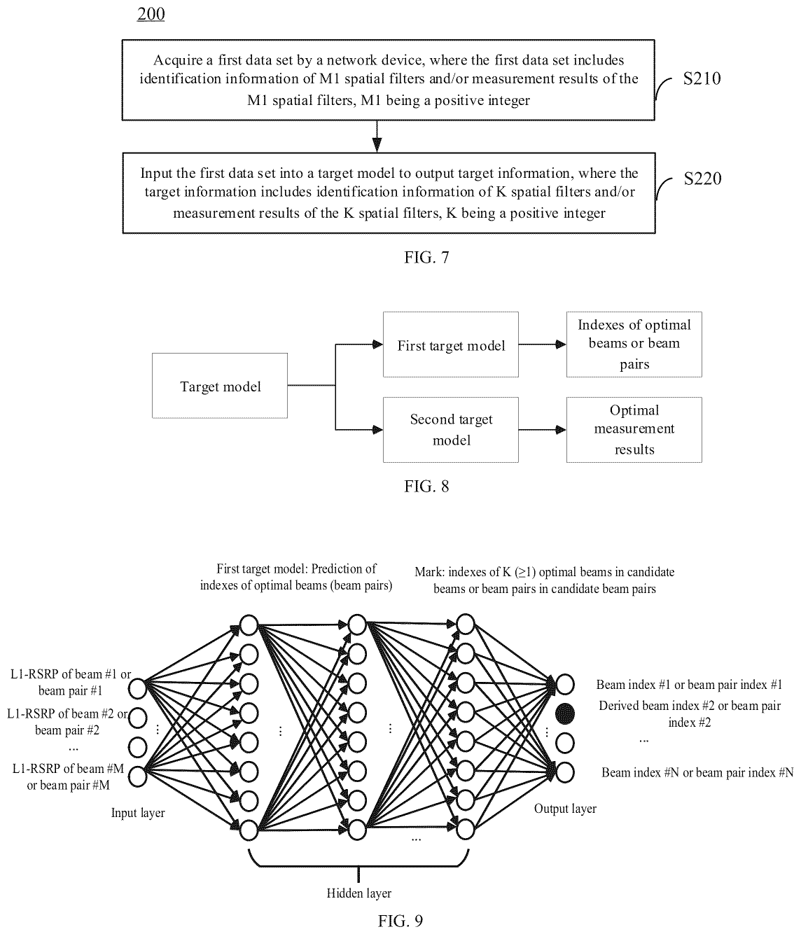

FIG. 7 is a schematic flowchart of a method for wireless communication 200 according to some embodiments of the present disclosure. The method 200 is performed by the network device in the communication system shown in FIG. 1. As shown in FIG. 7, the method 200 includes at least part of the following contents.

In S210, a first data set is acquired by a network device, where the first data set includes identification information of M1 spatial filters and/or measurement results of the M1 spatial filters, M1 being a positive integer.

In S220, the first data set is input into a target model, and target information is output, where the target information includes identification information of K spatial filters and/or measurement results of the K spatial filters, K being a positive integer.

In some embodiments, the spatial filter is also referred to as a beam, a spatial relation, a spatial setting, a spatial domain filter, or a reference signal. In some embodiments, the spatial filter includes a Tx spatial filter (or Tx spatial domain filter) and/or an Rx spatial filter (or Rx spatial domain filter). For example, the spatial filter includes a Tx spatial filter.

For another example, the spatial filter includes a combination of a Tx spatial filter and an Rx spatial filter.

In some embodiments, the Tx spatial filter is also referred to as a Tx beam or a Tx spatial domain filter, which are used interchangeably.

In some embodiments, the Rx spatial filter is also referred to as an Rx beam or an Rx spatial domain filter, which are used interchangeably.

In some embodiments, the combination of the Tx spatial filter and the Rx spatial filter is also referred to as a beam pair, a spatial filter pair, and a spatial filter bank, which are used interchangeably.

In some embodiments, the K spatial filters include K Tx spatial filters, denoted as Case 1.

That is, the target information inferred by the network device based on the target model is information of K Tx beams.

In this case, the target information includes identification information of the K Tx beams and/or measurement results of the K Tx beams.

In other embodiments, the K spatial filters include K combinations of Tx spatial filters and Rx spatial filters, denoted as Case 2. That is, the target information inferred by the network device based on the target model is information of K beam pairs.

In this case, the target information includes identification information of the K beam pairs and/or measurement results of the K beam pairs.

In some embodiments, the identification information of the spatial filter is an index of the spatial filter.

For example, the identification information of the Tx spatial filter is an index of the Tx spatial filter.

For another example, the identification information of the Rx spatial filter is an index of the Rx spatial filter.

For still another example, the identification information of the combination of the Tx spatial filter and the Rx spatial filter is an index of the combination.

In some embodiments, the measurement result of the spatial filter includes, but is not limited to, at least one of:
a layer-1 reference signal received power (L1-RSRP), a layer-1 reference signal received quality (L1-RSRQ), or a layer-1 signal-to-interference-plus-noise ratio (L1-SINR).

In some embodiments, the first data set is acquired from a terminal device.

In some embodiments, the first data set is acquired by measuring a portion of spatial filters in a candidate spatial filter set by the terminal device, where the candidate spatial filter set includes N spatial filters, N being a positive integer.

In some embodiments, the first data set includes identification information of M1 Tx spatial filters and/or measurement results of the M1 Tx spatial filters.

In some embodiments, the first data set includes identification information of M1 combinations of Tx spatial filters and Rx spatial filters and/or measurement results of the M1 combinations.

In some embodiments, the candidate spatial filter set is configured by the network device.

In some embodiments, the candidate spatial filter set is considered as a complete spatial filter set.

In some embodiments, the candidate spatial filter set includes N Tx spatial filters.

That is, the candidate spatial filter set includes N Tx beams.

In some embodiments, the candidate spatial filter set includes N combinations of Tx spatial filters and Rx spatial filters.

That is, the candidate spatial filter set includes N beam pairs, where each of the beam pairs includes a Tx beam and an Rx beam.

In some embodiments, the M1 spatial filters are spatial filters actually used in a downlink beam scanning process.

That is, the M1 spatial filters are a subset of the complete spatial filter set.

In some embodiments, the M1 spatial filters are also referred to as a set of measured spatial filters.

In some embodiments, M1 is less than N, that is, the network device transmits a downlink reference signal by using only a portion of spatial filters in the candidate spatial filter set, instead of transmitting the downlink reference signal by using all the spatial filters, which is beneficial to reducing the overhead and delay of beam selection.

In some embodiments, the identification information of the K spatial filters and the measurement results of the K spatial filters are output by the same model, or output by different models, which is not limited in the present disclosure.

For example, as shown in FIG. 8, the target model includes a first target model and a second target model. The first target model is configured to output the identification information of the K spatial filters, such as indexes of K optimal beams or beam pairs, and the second target model is configured to output the measurement results of the K spatial filters, such as measurement results of the K optimal beams or beam pairs. The first target model and the second target model use the same input, i.e., the first data set.

FIG. 9 shows an example of a model structure and a relationship between the input and output of the first target model.

As shown in FIG. 9, the input of the first target model is the indexes of the beams or beam pairs and the corresponding measurement results, a label is the indexes of the K beams or beam pairs with the best measurement results (or with the best link qualities), and the output is the indexes of the K beams or beam pairs with the best measurement results.

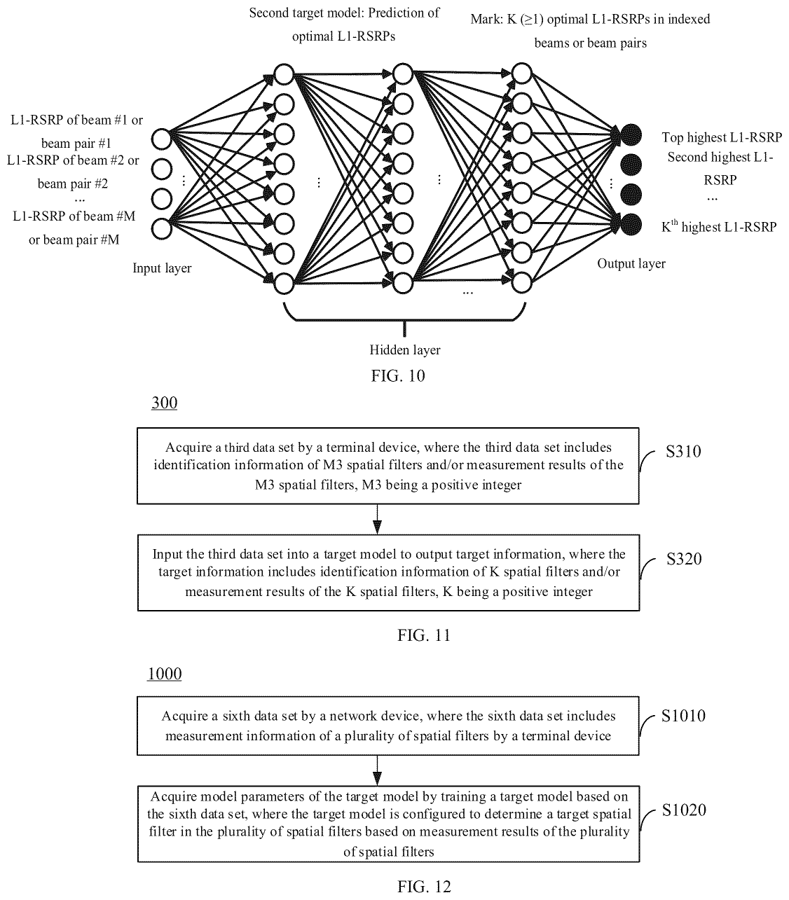

FIG. 10 shows an example of a model structure and a relationship between the input and output of the second target model.

As shown in FIG. 10, the input of the second target model is the indexes of the beams or beam pairs and the corresponding measurement results, a label is the measurement results of the K beams or beam pairs with the best measurement results (or with the best link qualities), and the output is the measurement results of the K optimal beams or beam pairs.

In some embodiments, the number of beams or beam pairs output by inferring the optimal beams or beam pairs by using the target model is the same as or less than that marked during training of the target model.

That is, in the case that K beams or beam pairs are marked during the training of the target model, K beams or beam pairs are output or less than K beams or beam pairs are output in inferring the optimal beams or beam pairs by using the target model. The present disclosure only illustrates by outputting the same number of beams or beam pairs, but the present disclosure is not limited thereto.

In some embodiments, the target model is a CNN, an RNN, or another neural network model, which is not limited in the present disclosure.

In some embodiments of the present disclosure, the target model is acquired by training by the network device.

In some embodiments, the method 200 further includes:
acquiring a second data set by the network device; and
training the target model based on the second data set to acquire model parameters of the target model.

The second data set is acquired from the terminal device.

In some embodiments, the second data set includes partial measurement information acquired by the terminal device in the downlink full scanning process, and optimal spatial filter information determined based on all measurement information acquired by the terminal device in the downlink full scanning process.

In some embodiments, the second data set includes at least one of:
identification information of M2 spatial filters, M2 being a positive integer;
measurement results of the M2 spatial filters;
identification information of P marked optimal spatial filters, P being a positive integer; or measurement results of the P marked optimal spatial filters.

In some embodiments, the M2 spatial filters include a portion of spatial filters in the candidate spatial filter set, and the P spatial filters are acquired by measuring all the spatial filters in the candidate spatial filter set by the terminal device.

It should be understood that, in the embodiments of the present disclosure, the target model is acquired by offline training, online training, or a combination of offline training and online training. For example, the network device first acquires a static training result through offline training, and further predicts the optimal beams or beam pairs by using the offline-trained model. During subsequent measurement and/or reporting of the terminal device, the network device continues to collect more measurement data, and then continues training the target model to optimize the model parameters by using the measurement results, such that a better predicting result is acquired.

In some embodiments, P is equal to K, or P is greater than K.

That is, an optimal number of the optimal spatial filters inferred by using the target model is less than or equal to the number of optimal spatial filters marked during the training of the target model.

In some embodiments of the present disclosure, the method 200 further includes:

transmitting, by the network device, a model type and/or model parameters of the target model to the terminal device.

For example, in the case that both the terminal device and the network device predict the optimal spatial filters based on the target model, the network device transmits the model type and/or model parameters of the target model to the terminal device.

Further, the terminal device constructs the target model based on the above information, and then infers the optimal beams or beam pairs by using the target model after acquiring the measurement results by performing the downlink scanning process.

In some embodiments, the model type of the target model is DNN, RNN, etc.

In some embodiments, the model type and model parameters of the target model are used to construct the target model by the terminal device.

In some embodiments, the model parameters of the target model indicate parameters, such as a network structure (e.g., layers included) of the target model, and connection relationships between the layers.

In other embodiments of the present disclosure, the target model is acquired by training by the terminal device.

For example, the terminal device acquires a data set for model training, and further trains the target model based on the data set to acquire the model parameters of the target model.

In some embodiments, the network device triggers the downlink full scanning process (i.e., the P1 process), and the terminal device traverses all the Rx spatial filters to receive the downlink reference signals, resulting in a measurement result set.

Further, the terminal device selects the highest K measurement results from the measurement result set, marks the K measurement results as K optimal measurement results, and marks the spatial filters corresponding to the K measurement results as K optimal spatial filters.

In some embodiments, the data set for model training includes a portion of measurement results in the measurement result set and identification information of the spatial filters corresponding to the portion of measurement results; and the marked highest K measurement results and identification information of the spatial filters corresponding to the highest K measurement results.

For example, in the case that the terminal device trains the target model and the network device infers the optimal spatial filters by using the target model, the terminal device transmits information of the trained target model to the network device.

In some embodiments of the present disclosure, the method 200 further includes:

receiving, by the network device, model type and/or model parameter information of the target model transmitted by the terminal device.

After the model training is completed, the terminal device transmits the model type and/or model parameters of the target model to the network device. Further, the network device constructs the target model based on the model type and/or model parameters of the target model.

In some embodiments of the present disclosure, the method 200 further includes:

transmitting, by the network device, first indication information to the terminal device, where the first indication information indicates the K spatial filters.

For example, after the network device infers and determines the K spatial filters based on the target model, the network device indicates the K spatial filters to the terminal device.

In some embodiments, the first indication information is transmitted over an MAC CE or a DCI.

In Case 1, the K spatial filters are K Tx spatial filters.

That is, the network device acquires the K Tx spatial filters by inference.

In some embodiments, the first indication information indicates K TCI states, and the K TCI states correspond to the K Tx spatial filters. That is, the network device uses the TCI states to indicate the optimal Tx beams.

In Case 2, the K spatial filters are K combinations of Tx spatial filters and Rx spatial filters.

That is, the network device acquires the K combinations of Tx spatial filters and Rx spatial filters by inference.

In this case, the network device indicates K Tx spatial filters in the K combinations of Tx spatial filters and Rx spatial filters to the terminal device, or indicates the K combinations of Tx spatial filters and Rx spatial filters to the terminal device.

In Mode 1, the first indication information indicates K TCI states, and the K TCI states correspond to K Tx spatial filters in the K combinations of Tx spatial filters and Rx spatial filters.

That is, in the case that the network device acquires the K combinations of Tx spatial filters and Rx spatial filters by inference, the network device indicates to the terminal device only the Tx spatial filters by using the TCI states.

In Mode 2, the first indication information indicates identification information of the Tx spatial filter and identification information of the Rx spatial filter in each of the K combinations.

That is, in the case that the network device acquires the K combinations of Tx spatial filters and Rx spatial filters by inference, the network device indicates to the terminal device the identification information of the Tx spatial filters and the identification information of the Rx spatial filters.

In some embodiments, the Tx spatial filters are indicated by the TCI states.

In some embodiments, the first indication information is transmitted over an MAC CE or a DCI.

For example, an information field is added to the MAC CE or the DCI to indicate the identification information of the Rx spatial filters.

In Mode 3, the first indication information indicates K TCI states, and the K TCI states correspond to the K combinations of Tx spatial filters and Rx spatial filters.

That is, in the case that the network device acquires the K combinations of Tx spatial filters and Rx spatial filters by inference, the network device indicates to the terminal device the Tx spatial filters and the Rx spatial filters by using the TCI states. The TCI states in this case are considered as an increased spatial filter indication method.

In Mode 4, the first indication information is the identification information of each of the K combinations.

That is, in the case that the network device acquires the K combinations of Tx spatial filters and Rx spatial filters by inference, the network device indicates to the terminal device the identification information of the combination, where the identification information of the combination indicates a combination of a Tx spatial filter and an Rx spatial filter.

In some embodiments, in the case that the K spatial filters belong to the M1 spatial filters, the network device transmits the first indication information to the terminal device.

For example, in the case that the K Tx spatial filters inferred by the network device belong to the M1 Tx spatial filters (a set of measured Tx spatial filters), the network device transmits the first indication information to the terminal device.

It should be understood that, in the case that the K Tx spatial filters inferred by the network device belong to the set of measured Tx spatial filters, the terminal device may acknowledge which Rx spatial filter is used to receive the downlink reference signals transmitted by the network device by using the K Tx spatial filters, and therefore, it is not necessary to further perform a downlink beam scanning process to determine the optimal Rx spatial filters.

In some embodiments, the M1 spatial filters include M1 Tx spatial filters, the K spatial filters include a first Tx spatial filter, or the M1 combinations of Tx spatial filters and Rx spatial filters include a combination of a first Tx spatial filter and a first Rx spatial filter. In the case that the first Tx spatial filter does not belong to the M1 Tx spatial filters, the method 200 further includes:

transmitting first trigger information to the terminal device by the network device, where the first trigger information is used to trigger the terminal device to traverse all Rx spatial filters to receive a downlink reference signal transmitted by the first Tx spatial filter to determine an optimal Rx spatial filter.

That is, in the case that the Tx spatial filters inferred by the network device do not belong to the M1 Tx spatial filters (the set of measured Tx spatial filters), the network device triggers the P3 process. It should be understood that, in the case that the Tx spatial filters inferred by the network device do not belong to the set of measured Tx spatial filters, the terminal device may not acknowledge which Rx spatial filter is used to receive the downlink reference signals transmitted by the network device by using the Tx spatial filters, and therefore, it is necessary to make a further determination based on the P3 process.

For example, the network device triggers an aperiodic P3 process, such as transmitting a CSI-RS resource set with a repetition set to ON. The network device transmits all CSI-RS resources in the CSI-RS resource set by using the first Tx spatial filter. Correspondingly, the UE determines an optimal Rx spatial filter corresponding to the first Tx spatial filter by converting different Rx spatial filters to receive the CSI-RS resources.

It should be understood that, in some embodiments of the present disclosure, in the case that both the terminal device and the network device predict the optimal spatial filters based on the target model, the terminal device infers the optimal spatial filters based on the target model. In this case, the network device does not transmit the first indication information to the terminal device. In some embodiments, in the case that the optimal Tx spatial filters inferred by the terminal device and the network device are not in the set of measured Tx spatial filters, the network device triggers the P3 process to determine the optimal Rx spatial filters corresponding to the optimal Tx spatial filters. In some embodiments of the present disclosure, the method 200 further includes:

receiving, by the network device, first capability information transmitted by the terminal device, where the first capability information indicates a capability of the terminal device to train the target model and/or a capability of the terminal device to predict (or infer) the target information by using the target model.

That is, the terminal device indicates to the network device its training capability and/or inference capability for the model for spatial filter prediction.

In some embodiments, the first capability information includes at least one of:
information indicating whether the terminal device supports predicting the target information based on a model, i.e., whether the terminal device supports predicting the optimal spatial filters based on a model;
information indicating whether the terminal device supports training the target model;
information indicating whether the terminal device supports determining the target information by using the target model;
a size of a training data set supported by the terminal device, e.g., a supported number of bytes;
a type of model supported by the terminal device, e.g., CNN or RNN that is supported;
a configuration of model supported by the terminal device; or
a type of data supported by the terminal device for predicting the target information.

In some embodiments, the configuration of a model supported by the terminal device includes at least one of:
a number of input parameters, a number of hidden layers, or a number of output parameters.

In some embodiments of the present disclosure, the method 200 further includes:
transmitting, by the network device, first configuration information to the terminal device based on the first capability information, where the first configuration information is used to configure the terminal device to train the target model and/or predict the target information by using the target model.

For example, in the case that the terminal device supports training to acquire the target model, the network device instructs the terminal device to train the target model.

For another example, in the case that the terminal device supports predicting the optimal spatial filters by using the target model, the network device instructs the terminal device to predict the optimal spatial filters by using the target model.

For still another example, in the case that the terminal device supports training to acquire the target model and predicting the optimal spatial filters by using the target model, the network device instructs the terminal device to train the target model and predict the optimal spatial filters by using the target model.

In some embodiments, the first configuration information is further used to configure a type of the target model used by the terminal device.

For example, the first configuration information is used to configure the target model to be implemented by CNN or RNN.

It should be understood that the first configuration information may be transmitted over any downlink signaling. By way of example and not limitation, the first configuration information is transmitted over radio resource control (RRC) signaling.

In summary, in the embodiments of the present disclosure, the network device only needs to scan a portion of the spatial filters, and the terminal device only needs to measure the portion of the spatial filters, such that the optimal spatial filters are predicted by using the trained target model, thereby reducing the overhead and delay generated by downlink beam scanning.

FIG. 11 is a schematic flowchart of a method for wireless communication 300 according to other embodiments of the present disclosure. The method 300 is performed by the terminal device in the communication system shown in FIG. 1. As shown in FIG. 11, the method 300 includes the following contents.

In S310, a third data set is acquired by a terminal device, where the third data set includes identification information of M3 spatial filters and/or measurement results of the M3 spatial filters, M3 being a positive integer.

In S320, the third data set is input into a target model, and target information is output, where the target information includes identification information of K spatial filters and/or measurement results of the K spatial filters, K being a positive integer.

It should be understood that reference may be made to the related description in the method 200 for a related description of the spatial filters in the method 300, which is not repeated herein for brevity.

In some embodiments, the K spatial filters include K Tx spatial filters, denoted as Case 1. That is, the target information inferred by the terminal device based on the target model is information of K Tx beams.

In this case, the target information includes identification information of the K Tx beams and/or measurement results of the K Tx beams.

In other embodiments, the K spatial filters include K combinations of Tx spatial filters and Rx spatial filters, denoted as Case 2. That is, the target information inferred by the terminal device based on the target model is information of K beam pairs.

In this case, the target information includes identification information of the K beam pairs and/or measurement results of the K beam pairs.

In some embodiments, the third data set is acquired by measuring a portion of spatial filters in a candidate spatial filter set by the terminal device, where the candidate spatial filter set includes N spatial filters, N being a positive integer.

In some embodiments, the third data set includes identification information of M3 Tx spatial filters and/or measurement results of the M3 Tx spatial filters.

In some embodiments, the third data set includes identification information of M3 combinations of Tx spatial filters and Rx spatial filters and/or measurement results of the M3 combinations.

It should be understood that reference may be made to the related description in the method 200 for the candidate spatial filter set, which is not repeated herein for brevity.

In some embodiments, the M3 spatial filters are spatial filters actually used in a downlink beam scanning process.

That is, the M3 spatial filters are a subset of the complete spatial filter set.

In some embodiments, the M3 spatial filters are also referred to as a set of measured spatial filters.

In some embodiments, M3 is less than N, that is, the network device transmits a downlink reference signal by using only a portion of spatial filters in the candidate spatial filter set, instead of transmitting the downlink reference signal by using all the spatial filters, which is beneficial to reducing the overhead and delay of beam selection.

In some embodiments, the identification information of the K spatial filters and the measurement results of the K spatial filters are output through the same model, or output through different models, which is not limited in the present disclosure.

For example, as shown in FIG. 8, the target model includes a first target model and a second target model. The first target model is configured to output the identification information of the K spatial filters, such as indexes of K optimal beams or beam pairs, and the second target model is configured to output the measurement results of the K spatial filters, such as measurement results of the K optimal beams or beam pairs. The first target model and the second target model use the same input, i.e., the first data set.

FIG. 9 shows an example of a model structure and a relationship between the input and output of the first target model.

As shown in FIG. 9, the input of the first target model is the indexes of the beams or beam pairs and the corresponding measurement results, a label is the indexes of the K beams or beam pairs with the best measurement results (or with the best link qualities), and the output is the indexes of the K beams or beam pairs with the best measurement results.

FIG. 10 shows an example of a model structure and a relationship between the input and output of the second target model.

As shown in FIG. 10, the input of the second target model is the indexes of the beams or beam pairs and the corresponding measurement results, a label is the measurement results of the K beams or beam pairs with the best measurement results (or with the best link qualities), and the output is the measurement results of the K optimal beams or beam pairs.

In some embodiments, the number of beams or beam pairs output by inferring the optimal beams or beam pairs by using the target model is the same as or less than that marked during training of the target model.

That is, in the case that K beams or beam pairs are marked during the training of the target model, K beams or beam pairs are output or less than K beams or beam pairs are output in inferring the optimal beams or beam pairs by using the target model. The present disclosure only illustrates by outputting the same number of beams or beam pairs, but the present disclosure is not limited thereto.

In some embodiments, the target model is a CNN, an RNN, or another neural network model, which is not limited in the present disclosure.

In some embodiments of the present disclosure, the target model is acquired by training by the network device.

In some embodiments, the method 300 further includes:
transmitting, by the terminal device, a fourth data set to the network device, where the fourth data set is configured to train the target model by the network device to acquire model parameters of the target model.

In some embodiments, the fourth data set includes partial measurement information acquired by the terminal device in the downlink full scanning process, and optimal spatial filter information determined based on all measurement information acquired by the terminal device in the downlink full scanning process.

In some embodiments, the fourth data set includes at least one of:
identification information of M4 spatial filters, M4 being a positive integer;
measurement results of the M4 spatial filters;
identification information of Q optimal spatial filters, Q being a positive integer; or
measurement results of the Q optimal spatial filters.

In some embodiments, the M4 spatial filters include a portion of spatial filters in the candidate spatial filter set, and the Q spatial filters are acquired by measuring all the spatial filters in the candidate spatial filter set by the terminal device.

In some embodiments, Q is equal to K, or Q is greater than K.

That is, an optimal number of the optimal spatial filters inferred by using the target model is less than or equal to the number of optimal spatial filters marked during the training of the target model.

In some embodiments of the present disclosure, the method 300 further includes:
receiving, by the terminal device, model type and/or model parameter information of the target model transmitted by the network device.

That is, after acquiring the target model by training based on the fourth data set, the network device transmits the model type and/or model parameter information of the target model to the terminal device.

For example, in the case that the network device trains the target model and the terminal device infers the optimal spatial filters by using the target model, the network device transmits information of the trained target model to the terminal device.

In some embodiments, the model type and model parameters of the target model are configured to construct the target model by the terminal device.

In some embodiments, the model parameters of the target model indicate parameters, such as a network structure (e.g., layers included) of the target model, and connection relationships between the layers.

In still other embodiments of the present disclosure, the target model is acquired by training by the terminal device.

In some embodiments, the method 300 further includes:
acquiring a fifth data set by the terminal device; and
training, by the terminal device, the target model based on the fifth data set to acquire model parameters of the target model.

In some embodiments, the fifth data set includes partial measurement information acquired by the terminal device in the downlink full scanning process, and optimal spatial filter information determined based on all measurement information acquired by the terminal device in the downlink full scanning process.

In some embodiments, the fifth data set includes at least one of:
identification information of M5 spatial filters, M5 being a positive integer;
measurement results of the M5 spatial filters;
identification information of X optimal spatial filters; or
measurement results of the X optimal spatial filters.

In some embodiments, the M5 spatial filters include a portion of spatial filters in the candidate spatial filter set, and the X spatial filters are acquired by measuring all the spatial filters in the candidate spatial filter set by the terminal device.

In some embodiments, the method 300 further includes:
transmitting, by the terminal device, model type and/or model parameter information of the target model to the network device.

For example, in the case that both the terminal device and the network device predict the optimal spatial filters based on the target model, the network device transmits information of the target model to the terminal device.

In some embodiments of the present disclosure, the method 300 further includes:
transmitting, by the terminal device, second indication information to the network device, where the second indication information indicates the K spatial filters.

In Case 1, the K spatial filters are K Tx spatial filters.

That is, the network device acquires the K Tx spatial filters by inference.

In some embodiments, in this case, the second indication information indicates identification information of the K Tx spatial filters, for example, indexes of K Tx beams.

In Case 2, the K spatial filters are K combinations of Tx spatial filters and Rx spatial filters.

That is, the network device acquires the K combinations of Tx spatial filters and Rx spatial filters by inference.

In this case, the terminal device indicates K Tx spatial filters in the K combinations of Tx spatial filters and Rx spatial filters to the terminal device, or indicates the K combinations of Tx spatial filters and Rx spatial filters to the terminal device.

In Mode 1, the second indication information indicates identification information of the Tx spatial filter in each of the K combinations.

That is, in the case that the terminal device acquires the K combinations of Tx spatial filters and Rx spatial filters by inference, the terminal device indicates to the network device the identification information of the Tx spatial filter in each of the combinations, where the identification information of the Tx spatial filter indicates a Tx spatial filter.

In Mode 2, the second indication information indicates the identification information of each of the K combinations.

That is, in the case that the terminal device acquires the K combinations of Tx spatial filters and Rx spatial filters by inference, the terminal device indicates to the network device the identification information of each combination, where the identification information of the combination indicates a combination of a Tx spatial filter and an Rx spatial filter.

In Mode 3, the second indication information indicates the identification information of the Tx spatial filter and identification information of the Rx spatial filter in each of the K combinations.

That is, in the case that the terminal device acquires the K combinations of Tx spatial filters and Rx spatial filters by inference, the terminal device indicates to the network device the identification information of the Tx spatial filter and the identification information of the Rx spatial filter in each of the combinations, where the identification information of the Tx spatial filter indicates a Tx spatial filter, and the identification information of the Rx spatial filter indicates an Rx spatial filter.

In some embodiments, in the case that the K spatial filters belong to the M3 spatial filters, the terminal device transmits the second indication information to the network device.

For example, in the case that the K Tx spatial filters inferred by the terminal device belong to the M3 Tx spatial filters (a set of measured Tx spatial filters), the terminal device transmits the second indication information to the network device.

It should be understood that, in the case that the K Tx spatial filters inferred by the terminal device belong to the set of measured Tx spatial filters, the terminal device may acknowledge which Rx spatial filter is used to receive the downlink reference signals transmitted by the network device by using the K Tx spatial filters, and therefore, it is not necessary to further perform a downlink beam scanning process to determine the optimal Rx spatial filters.

In some embodiments of the present disclosure, the method 300 further includes:
receiving, by the terminal device, third indication information transmitted by the network device, where the third indication information indicates a target spatial filter determined by the network device in the K spatial filters.

For example, after receiving the second indication information, the network device acknowledges the identification information of the K spatial filters. Further, the network device determines the target spatial filter in the K spatial filters, and then indicates the target spatial filter to the terminal device through the third indication information.

It should be understood that reference may be made to the indication of the first indication information in the method 200 for the indication of the third indication information, which is not repeated herein for brevity.

In some embodiments, the target filter includes a target Tx spatial filter, the third indication information indicates at least one transmission configuration indicator (TCI) state, and the at least one TCI state corresponds to the target Tx spatial filter.

In some embodiments, the target filter includes a combination of a target Tx spatial filter and a target Rx spatial filter, the third indication information indicates at least one TCI state, and the at least one TCI state corresponds to the target Tx spatial filter in the combination.

In some embodiments, the target filter includes a combination of a target Tx spatial filter and a target Rx spatial filter, the third indication information indicates at least one TCI state, and the at least one TCI state corresponds to the combination.

In some embodiments, the target filter includes a combination of a target Tx spatial filter and a target Rx spatial filter, and the third indication information indicates identification information of the target Tx spatial filter and identification information of the target Rx spatial filter.

In some embodiments, the target filter includes a combination of a target Tx spatial filter and a target Rx spatial filter, and the third indication information indicates identification information of the combination.

In other embodiments of the present disclosure, in the case that a second spatial filter in the K spatial filters does not belong to the M3 spatial filters, the method 300 further includes:
transmitting, by the terminal device, fourth indication information to the network device, where the fourth indication information is configured to trigger the network device to transmit a downlink reference signal by using the second spatial filter.

In some embodiments, the case that the second spatial filter in the K spatial filters does not belong to the M3 spatial filters includes:
a case where the K spatial filters are K Tx spatial filters including a second Tx spatial filter, and the second Tx spatial filter does not belong to the M3 Tx spatial filters; or
a case where the K spatial filters are K combinations of Tx spatial filters and Rx spatial filters including a combination of a second Tx spatial filter and a second Rx spatial filter, and the combination of the second Tx spatial filter and the second Rx spatial filter does not belong to the M3 combinations of Tx spatial filters and Rx spatial filters.

For example, in the case that the Tx spatial filters inferred by the terminal device do not belong to the M3 Tx spatial filters (a set of measured Tx spatial filters), the terminal device triggers the P1 process of the network device. It should be understood that, in the case that the Tx spatial filters inferred by the terminal device do not belong to the set of measured Tx spatial filters, the terminal device may not acknowledge which Rx spatial filter is used to receive the downlink reference signals transmitted by the network device by using the Tx spatial filters, and therefore, it is necessary to make a further determination based on the P3 process.

For example, the network device triggers an aperiodic P3 process based on the fourth indication information, such as transmitting a CSI-RS resource set with a repetition set to ON. The network device transmits all CSI-RS resources in the CSI-RS resource set by using the first Tx spatial filter. Correspondingly, the UE determines an optimal Rx spatial filter corresponding to the first Tx spatial filter by converting different Rx spatial filters to receive the CSI-RS resources.

It should be understood that, in some embodiments of the present disclosure, in the case that both the terminal device and the network device predict the optimal spatial filters based on the target model, the network device infers the optimal spatial filters based on the target model. In this case, the terminal device does not transmit the second indication information to the network device. In some embodiments, in the case that the optimal Tx spatial filters inferred by the terminal device and the network device are not in the set of measured Tx spatial filters, the terminal device instructs the network device to trigger the P3 process to determine the optimal Rx spatial filters corresponding to the optimal Tx spatial filters.

In some embodiments of the present disclosure, the method 300 further includes:
transmitting, by the terminal device, first capability information to the network device, where the first capability information indicates a capability of the terminal device to train the target model and/or a capability of the terminal device to predict the target information by using the target model.

That is, the terminal device indicates to the network device its training capability and/or inference capability for the model for spatial filter prediction.

In some embodiments, the first capability information includes at least one of:
information indicating whether the terminal device supports predicting the target information based on a model, i.e., whether the terminal device supports predicting the optimal spatial filters based on a model;
information indicating whether the terminal device supports training the target model;
information indicating whether the terminal device supports determining the target information by using the target model;
a size of a training data set supported by the terminal device, e.g., a supported number of bytes;
a type of model supported by the terminal device, e.g., CNN or RNN that is supported;
a configuration of model supported by the terminal device; or
a type of data supported by the terminal device for predicting the target information.

In some embodiments, the configuration of a model supported by the terminal device includes at least one of:
a number of input parameters, a number of hidden layers, or a number of output parameters.

In some embodiments of the present disclosure, the method 300 further includes:
receiving, by the terminal device, first configuration information of the network device, where the first configuration information is used to configure the terminal device to train the target model and/or predict the target information by using the target model.

For example, in the case that the terminal device supports training to acquire the target model, the network device instructs the terminal device to train the target model.

For another example, in the case that the terminal device supports predicting the optimal spatial filters by using the target model, the network device instructs the terminal device to predict the optimal spatial filters by using the target model.

For still another example, in the case that the terminal device supports training to acquire the target model and predicting the optimal spatial filters by using the target model, the network device instructs the terminal device to train the target model and predict the optimal spatial filters by using the target model.

In some embodiments, the first configuration information is further used to configure a type of the target model used by the terminal device.

For example, the first configuration information is used to configure the target model to be implemented by CNN or RNN.

It should be understood that the first configuration information may be transmitted over any downlink signaling. By way of example and not limitation, the first configuration information is transmitted over radio resource control (RRC) signaling.

In summary, in the embodiments of the present disclosure, the network device only needs to scan a portion of the spatial filters, and the terminal device only needs to measure the portion of the spatial filters, such that the optimal spatial filters can be predicted by using the trained target model, thereby reducing the overhead and delay generated by downlink beam scanning.

FIG. 12 is a schematic flowchart of a method for wireless communication 1000 according to still other embodiments of the present disclosure. The method 1000 may be performed by the network device in the communication system shown in FIG. 1. As shown in FIG. 12, the method 1000 includes the following contents.

In S1010, a sixth data set is acquired by the network device, where the sixth data set includes measurement information of a plurality of spatial filters by a terminal device.

In S1020, a target model is trained based on the sixth data set to acquire model parameters of the target model, where the target model is configured to determine a target spatial filter in the plurality of spatial filters based on measurement results of the plurality of spatial filters.

In some embodiments, the sixth data set includes at least one of:
identification information of M6 spatial filters, M6 being a positive integer;
measurement results of the M6 spatial filters;
identification information of Y optimal spatial filters, Y being a positive integer; or
measurement results of the Y optimal spatial filters.

In some embodiments, the sixth data set includes partial measurement information acquired by the terminal device in the downlink full scanning process, and optimal spatial filter information determined based on all measurement information acquired by the terminal device in the downlink full scanning process.

It should be understood that, in the embodiments of the present disclosure, the target model is acquired by offline training, online training, or a combination of offline training and online training. For example, the network device first acquires a static training result through offline training, and further predicts the optimal beams or beam pairs by using the offline-trained model. During subsequent measurement and/or reporting of the terminal device, the network device continues to collect more measurement data, and then continues training the target model to optimize the model parameters by using the measurement results, such that a better predicting result is acquired.

In some embodiments, the M6 spatial filters include a portion of spatial filters in the candidate spatial filter set, and the Y spatial filters are acquired by measuring all the spatial filters in the candidate spatial filter set by the terminal device.

In some embodiments, the target model includes a first target model and a second target model, the first target model is configured to output identification information of K spatial filters, and the second target model is configured to output measurement results of the K spatial filters, K being a positive integer.

In some embodiments, Y is greater than or equal to K.

It should be understood that reference may be made to the related description in the method 200 for the related implementation of the target model, which is not repeated herein for brevity. In some embodiments, the method 1000 further includes:
transmitting, by the network device, model type and/or model parameter information of the target model to the terminal device.

For example, in the case that the network device trains the target model and the terminal device predicts the optimal spatial filters based on the target model, the network device transmits the model type and/or model parameters of the target model to the terminal device.

For another example, in the case that the network device trains the target model and both the terminal device and the network device predict the optimal spatial filters based on the target model, the network device transmits the model type and/or model parameters of the target model to the terminal device.

In some embodiments, the method 1000 further includes:
receiving, by the network device, first capability information transmitted by the terminal device, where the first capability information indicates a capability of the terminal device to train the target model and/or a capability of the terminal device to predict the target information by using the target model.

That is, the terminal device indicates to the network device its training capability and/or inference capability for the model for spatial filter prediction.

In some embodiments, the first capability information includes at least one of:
information indicating whether the terminal device supports predicting the target information based on a model, i.e., whether the terminal device supports predicting the optimal spatial filters based on a model;
information indicating whether the terminal device supports training the target model;
information indicating whether the terminal device supports determining the target information by using the target model;
a size of a training data set supported by the terminal device, e.g., a supported number of bytes;
a type of model supported by the terminal device, e.g., CNN or RNN that is supported;
a configuration of model supported by the terminal device; or
a type of data supported by the terminal device for predicting the target information.

In some embodiments, the configuration of a model supported by the terminal device includes at least one of:
a number of input parameters, a number of hidden layers, or a number of output parameters.

In some embodiments of the present disclosure, the method 200 further includes:
transmitting, by the network device, first configuration information to the terminal device based on the first capability information, where the first configuration information is used to configure the terminal device to train the target model and/or predict the target information by using the target model.

For example, in the case that the terminal device supports training to acquire the target model, the network device instructs the terminal device to train the target model.

For another example, in the case that the terminal device supports predicting the optimal spatial filters by using the target model, the network device instructs the terminal device to predict the optimal spatial filters by using the target model.

For still another example, in the case that the terminal device supports training to acquire the target model and predicting the optimal spatial filters by using the target model, the network device instructs the terminal device to train the target model and predict the optimal spatial filters by using the target model.

In some embodiments, the first configuration information is further used to configure a type of the target model used by the terminal device.

For example, the first configuration information is used to configure the target model to be implemented by CNN or RNN.

It should be understood that the first configuration information may be transmitted over any downlink signaling. By way of example and not limitation, the first configuration information is transmitted over radio resource control (RRC) signaling.

In some embodiments, the network device infers the optimal spatial filters by using the target model.

For example, the network device acquires a first data set from the terminal device, further inputs the first data set into the target model, and outputs the target information, where the target information includes identification information of K spatial filters and/or measurement results of the K spatial filters, K being a positive integer.

It should be understood that reference may be made to the related description in the method 200 for the specific implementation of inferring the optimal spatial filters by the network device based on the target model, which is not repeated herein for brevity.

In some embodiments, the network device further indicates the inferred K spatial filters to the terminal device.

For example, the network device transmits first indication information to the terminal device, where the first indication information indicates the K spatial filters. Reference may be made to the related description of the first indication information in the method 200 for the specific implementation of the first indication information, which is not repeated herein for brevity.

FIG. 13 is a schematic flowchart of a method for wireless communication 1100 according to still other embodiments of the present disclosure. The method 1100 may be performed by the terminal device in the communication system shown in FIG. 1. As shown in FIG. 13, the method 1100 includes the following contents.

In S1110, a seventh data set is acquired by a terminal device, where the seventh data set includes measurement information of a plurality of spatial filters by the terminal device.

In S1120, a target model is trained based on the seventh data set to acquire model parameters of the target model, where the target model is configured to determine a target spatial filter in the plurality of spatial filters based on measurement results of the plurality of spatial filters.

In some embodiments, the seventh data set includes partial measurement information acquired by the terminal device in the downlink full scanning process, and optimal spatial filter information determined based on all measurement information acquired by the terminal device in the downlink full scanning process.

In some embodiments, the seventh data set includes at least one of:
identification information of M7 spatial filters, M7 being a positive integer;
measurement results of the M7 spatial filters;
identification information of Z optimal spatial filters, Z being a positive integer; or
measurement results of the Z optimal spatial filters.

In some embodiments, the M7 spatial filters include a portion of spatial filters in the candidate spatial filter set, and the Z spatial filters are acquired by measuring all the spatial filters in the candidate spatial filter set by the terminal device.

In some embodiments, the target model includes a first target model and a second target model, the first target model is configured to output identification information of K spatial filters, and the second target model is configured to output measurement results of the K spatial filters, K being a positive integer.

It should be understood that reference may be made to the related description in the method 200 for the related implementation of the target model, which is not repeated herein for brevity. In some embodiments, the method 1100 further includes:
transmitting, by the terminal device, model type and/or model parameter information of the target model to the network device.

For example, in the case that the terminal device trains the target model and the network device predicts the optimal spatial filters based on the target model, the terminal device transmits the model type and/or model parameters of the target model to the network device.

For another example, in the case that the terminal device trains the target model and both the terminal device and the network device predict the optimal spatial filters based on the target model, the terminal device transmits the model type and/or model parameters of the target model to the network device.

In some embodiments, the method 1100 further includes:
transmitting, by the terminal device, first capability information to the network device, where the first capability information indicates a capability of the terminal device to train the target model and/or a capability of the terminal device to predict the target information by using the target model.

That is, the terminal device indicates to the network device its training capability and/or inference capability for the model for spatial filter prediction.

In some embodiments, the first capability information includes at least one of:
information indicating whether the terminal device supports predicting the target information based on a model, i.e., whether the terminal device supports predicting the optimal spatial filters based on a model;
information indicating whether the terminal device supports training the target model;
information indicating whether the terminal device supports determining the target information by using the target model;
a size of a training data set supported by the terminal device, e.g., a supported number of bytes;
a type of model supported by the terminal device, e.g., CNN or RNN that is supported;
a configuration of model supported by the terminal device; or
a type of data supported by the terminal device for predicting the target information.

In some embodiments, the configuration of a model supported by the terminal device includes at least one of:
a number of input parameters, a number of hidden layers, or a number of output parameters.

In some embodiments, the method 1100 further includes:
receiving, by the terminal device, first configuration information of the network device, where the first configuration information is used to configure the terminal device to train the target model and/or predict the target information by using the target model.

For example, in the case that the terminal device supports training to acquire the target model, the network device instructs the terminal device to train the target model.

For another example, in the case that the terminal device supports predicting the optimal spatial filters by using the target model, the network device instructs the terminal device to predict the optimal spatial filters by using the target model.

For still another example, in the case that the terminal device supports training to acquire the target model and predicting the optimal spatial filters by using the target model, the network device instructs the terminal device to train the target model and predict the optimal spatial filters by using the target model.

In some embodiments, the first configuration information is further used to configure a type of the target model used by the terminal device.

For example, the first configuration information is used to configure the target model to be implemented by CNN or RNN.

It should be understood that the first configuration information is transmitted over any downlink signaling. By way of example and not limitation, the first configuration information is transmitted over radio resource control (RRC) signaling.

In some embodiments, the terminal device infers the optimal spatial filters by using the target model.

For example, the terminal device acquires a third data set, further inputs the third data set into the target model, and outputs the target information, where the target information includes identification information of K spatial filters and/or measurement results of the K spatial filters, K being a positive integer.

It should be understood that reference may be made to the related description in the method 300 for the specific implementation of inferring the optimal spatial filters by the terminal device based on the target model, which is not repeated herein for brevity.

In some embodiments, the terminal device further indicates the inferred K spatial filters to the network device.

For example, the terminal device transmits second indication information to the network device, where the second indication information indicates the K spatial filters. Reference may be made to the related description of the second indication information in the method 300 for the specific implementation of the second indication information, which is not repeated herein for brevity.

Hereinafter, the specific implementation process will be described with reference to a first embodiment to a sixth embodiment, with the spatial filter being a beam or a beam pair, for example.

In a first embodiment, the network device trains the model and infers the optimal beams or beam pairs.

The first embodiment is applicable to a UE with weak computing power, and no neural network model is deployed at the terminal device side, such that the network device does not need to transmit model parameters to the UE after training the target model.

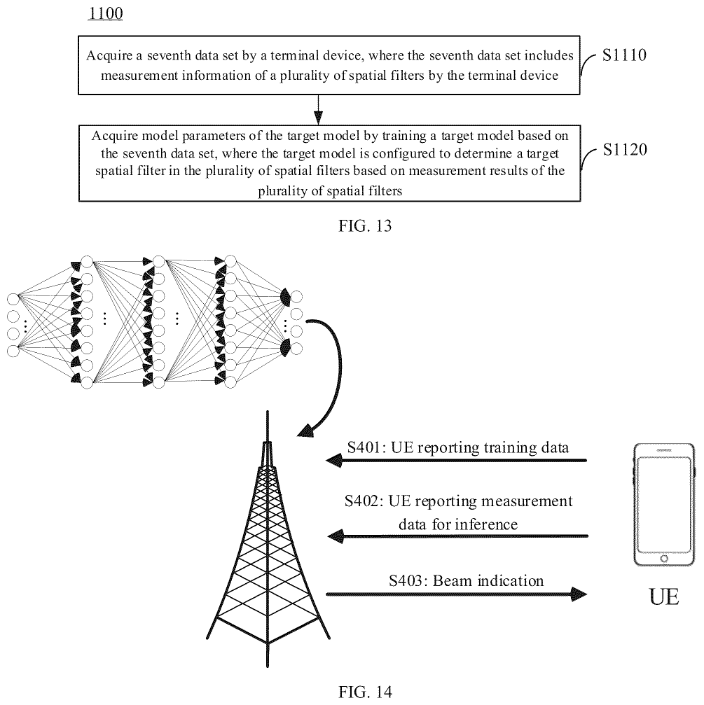

As shown in FIG. 14, the following steps are included.

In S401, the UE reports training data, for example, the aforementioned second data set, to the network device.

For example, the network device scans all Tx beams, such as the beams used by 64 SSBs. The UE measures the beam quality through a plurality of Rx beams of each Rx antenna panel.

The training data reported by the UE includes the following two parts:
a first part which is an input part of the model, i.e., M downlink beam indexes or beam pair indexes that are partially measured and corresponding measurement results; and
a second part which is a marked part of the model, i.e., K optimal downlink beams or beam pairs, and corresponding measurement results, e.g., L1-RSRPs.

The network device constructs a data set based on the training data reported by the UE, and trains the target model (for example, using a gradient descent algorithm) to acquire parameters on nodes in the model.

In S402, the UE reports measurement data for inference.

The measurement data includes measurement data corresponding to the beams or beam pairs that are partially measured, i.e., the network device only needs to scan a portion of the Tx beams, and the terminal device only needs to measure a portion of the Tx beams or beam pairs, which is beneficial to reducing the overhead and delay generated by the beam scanning process.

For example, the measurement data includes identification information and measurement results corresponding to the beams or beam pairs that are partially measured, such as identification information and corresponding measurement results of M beams or beam pairs.

After acknowledging the measurement data reported by the UE, the network device uses the measurement data as the input of the target model, for example, inputs the measurement data into the first target model and the second target model, separately, and runs the first target model and the second target model to infer indexes of K optimal beams or beam pairs and K measurement results corresponding thereto, such as K optimal L1-RSRPs.

In S403, the network device indicates a beam or a beam pair.

In Case 1, the network device acquires an optimal Tx beam by inference by using the target model.

In the case that the Tx beam is in a subset of measured Tx beams, the network device may indicate the Tx beam by a TCI state.

In the case that the Tx beam is not in a subset of measured Tx beams, the UE needs to measure the Tx beam to find a corresponding optimal Rx beam. Therefore, the network device may trigger an aperiodic P3 process, such as transmitting a CSI-RS resource set with a repetition set to ON, that is, all CSI-RS resources in the CSI-RS resource set are transmitted by using the Tx beam direction, and correspondingly, the UE determines the optimal Rx beam corresponding to the Tx beam by converting different Rx beams.

In Case 2, the network device acquires an optimal beam pair by inference by using the target model, where the optimal beam pair includes an optimal Tx beam and a corresponding Rx beam thereof.

In Case 2-1, the optimal beam pair is in a subset of measured beam pairs.

In Mode 1, the network device indicates the Tx beam by a TCI state and the UE finds the optimal Rx beam from the subset of measured beam pairs.

In Mode 2, the network device indicates to the UE the Tx beam (e.g., indicating based on the TCI state) and the Rx beam, separately.

For example, the TCI state is carried in a MAC CE or a DCI to indicate the Tx beam, and an information field is added to the MAC CE or the DCI to indicate the index of the Rx beam.

In Mode 3, the network device indicates the Tx beam and the Rx beam to the UE through the TCI state.

That is, the index of the Rx beam is jointly encoded into the TCI state.

For example, in the case that eight TCI states in an activated state are present, three bits are needed to indicate one of the states.

For each of the TCI states, the UE has four possible Rx beams, and then only two additional bits are needed to indicate the four Rx beams. That is, a total of five bits are needed to indicate the beam pair.

An advantage of joint encoding is as follows. Different TCI states may correspond to different numbers of Rx beams. For example, some TCI state corresponds to two Rx beams, and some TCI state corresponds to four Rx beams. As compared with adding a new information field for indicating the Rx beam, the length of joint encoding may be shorter.

In Mode 4, the network device indicates the index of the beam pair to the UE.

In Mode 5, the network device indicates the index of the Rx beam to the UE.

For example, the index of the Rx beam is carried in a DCI or an MAC CE.

As the terminal device does not need the Tx beam of the terminal network device, the network device only indicates the Rx beam, which is beneficial to reducing the signaling overhead.

In Case 2-2, the optimal beam pair is not in a subset of measured beam pairs. The UE has not measured the beam pair in advance, such that the UE does not know which Rx beam may be used for reception. For example, the network device may trigger the P3 process for the terminal device to determine the optimal Rx beam.

In a second embodiment, the network device trains the model and the terminal device infers the optimal beams or beam pairs.

The implementation process of the second embodiment maximizes the use of existing standards, with few modifications to the existing standards.

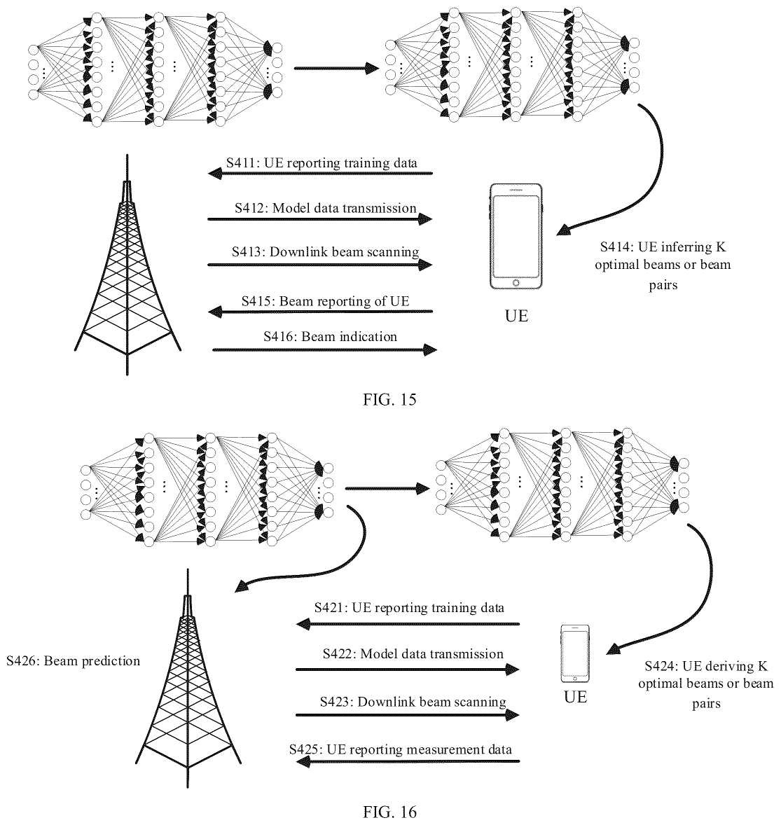

As shown in FIG. 15, the following steps are included.

In S411, the UE reports training data, for example, the aforementioned second data set, to the network device.

Reference is made to the related description of S401 in FIG. 14 for the specific implementation process, which is not repeated herein.

In S412, the network device transmits information of the trained model to the UE.

For example, model type and model parameter information is transmitted to the UE.

The UE constructs the target model by using the downloaded model type and model parameters for subsequent inference operations.

In S413, the downlink beams are scanned.

Specifically, the network device scans a portion of the Tx beams (or scans a subset of the beams), and the UE measures a portion of the Tx beams or beam pairs, which is beneficial to reducing the overhead and delay in the downlink beam scanning process.

In S414, the UE derives K optimal beams or beam pairs and corresponding measurement results by using the target model.

In S415, the UE indicates K Tx beams or beam pairs to the network device.

For example, the UE transmits second indication information to the network device, where the second indication information indicates the K Tx beams or beam pairs.

In Case 1, the UE acquires an optimal Tx beam by inference by using the target model.

In some embodiments, the UE indicates by a downlink reference signal corresponding to the Tx beam. For example, the Tx beam is represented by the index of the downlink reference signal corresponding thereto, for example, indicated by a CSI-RS resource indicator (CRI) or an SSB resource indicator (SSBRI).

In some embodiments, the UE reports the K Tx beams and measurement results corresponding thereto by using a beam reporting mechanism. For example, the K Tx beams and measurement results corresponding thereto are reported by a CSI field.

With K being equal to four, for example, the UE reports four Tx beams and measurement results corresponding thereto. The four Tx beams are indicated by CRIs or SSBRIs corresponding thereto. The measurement results corresponding to the four Tx beams are indicated by a reference measurement result and differential measurement results. For example, an absolute value of a measurement result of a Tx beam is reported, and the measurement results of the other Tx beams are indicated by differential values with respect to the absolute value.

Table 1 illustrates a reporting format for reporting the four Tx beams and measurement results corresponding thereto by the UE. CRI or SSBRI #n represents an index of a CSI-RS resource or an SSB resource corresponding to the Tx beam reported by the UE, and n=1, 2, 3, or 4. RSRP #1 represents an absolute value of L1-RSRP corresponding to CRI or SSBRI #1, Differential RSRP #2 represents a differential value of L1-RSRP corresponding to CRI or SSBRI #2 with respect to RSRP #1, Differential RSRP #3 represents a differential value of L1-RSRP corresponding to CRI or SSBRI #3 with respect to RSRP #1, and Differential RSRP #4 represents a differential value of L1-RSRP corresponding to CRI or SSBRI #4 with respect to RSRP #1.

TABLE 1

| CSI reporting number | CSI field |
|---|---|
| CSI reporting #n | CRI or SSBRI #1 |
| | CRI or SSBRI #2 |
| | CRI or SSBRI #3 |
| | CRI or SSBRI #4 |
| | RSRP #1 |
| | Differential RSRP #2 |
| | Differential RSRP #3 |
| | Differential RSRP #4 |

It should be understood that the embodiments of the present disclosure do not limit the specific reporting manner of the measurement results reported by the terminal device. For example, an absolute value of each measurement result is directly reported, or a plurality of measurement results are reported by an absolute value plus differential values, and the present disclosure is not limited thereto.

In Case 2, the UE acquires an optimal beam pair by inference by using the target model. In Mode 1, the UE only reports information of Tx beams in K beam pairs.

In Mode 2, the UE reports identification information of K beam pairs, such as indexes of the beam pairs, i.e., the identification information of a beam pair is used to identify a pair of a Tx beam and an Rx beam. That is, the identification information of the beam pair may be joint encoding of the Tx beam and the Rx beam.

In Mode 3, the UE reports identification information of each Tx beam and identification information of each Rx beam in K beam pairs.

The identification information of the Tx beam is used to identify a Tx beam, and the identification information of the Rx beam is used to identify an Rx beam.

In S416, the network device indicates a beam or a beam pair.

For example, after acknowledging the K beams or beam pairs reported by the UE, the network device selects a target beam or beam pair and further indicates the target beam or beam pair to the UE. For example, the network device may transmit third indication information to the UE for indicating the target beam or beam pair.

Reference is made to the indication of the first indication information for the indication of the third indication information, which is not repeated herein for brevity.

In a third embodiment, the network device trains the model and both the terminal device and the network device infer the optimal beams or beam pairs.

As shown in FIG. 16, the following steps are included.

In S421, the UE reports training data, for example, the aforementioned second data set, to the network device.

Reference may be made to the related description of S401 in FIG. 14 for the specific implementation process, which is not repeated herein.

In S422, the network device transmits information of the trained model to the UE.

For example, the model type and model parameter information is transmitted to the UE.

The UE constructs the target model by using the downloaded model type and model parameters for subsequent inference operations.

In S423, the downlink beams are scanned.

Specifically, the network device scans a portion of the Tx beams, and the UE measures the portion of the Tx beams or beam pairs, which is beneficial to reducing the overhead and delay in the downlink beam scanning process.

In S424, the UE derives K optimal beams or beam pairs and corresponding measurement results by using the target model.

For example, the UE inputs measurement data acquired in the downlink beam scanning process into the target model to acquire the K optimal beams or beam pairs and corresponding measurement results.

The measurement data includes measurement data corresponding to the beams or beam pairs that are partially measured. For example, the measurement data includes identification information and measurement results corresponding to the beams or beam pairs that are partially measured, such as identification information and corresponding measurement results of M beams or beam pairs.

In S425, the UE reports the measurement data for inference to the network device.

It should be understood that the present disclosure is not limited to the execution order of S424 and S425, and alternatively, S425 is performed first and then S424 is performed.

In S426, the network device derives K optimal beams or beam pairs and corresponding measurement results by using the target model.

For example, after acknowledging the measurement data reported by the UE, the network device uses the measurement data as the input of the target model, for example, inputs the measurement data into the first target model and the second target model, separately, and runs the first target model and the second target model to infer indexes of K optimal beams or beam pairs and K measurement results corresponding thereto, such as K optimal L1-RSRPs.

In this case, no indication of a beam or a beam pair is performed between the network device and the UE.

In some embodiments, in the case that the inferred Tx beam is not in a set of measured Tx beams, or that the inferred beam pair is not in a set of measured beam pairs, the network device triggers the P3 process to scan by using the inferred Tx beam to determine an Rx beam corresponding to the Tx beam.

In a fourth embodiment, the terminal device trains the model and the terminal device infers the optimal beams or beam pairs.

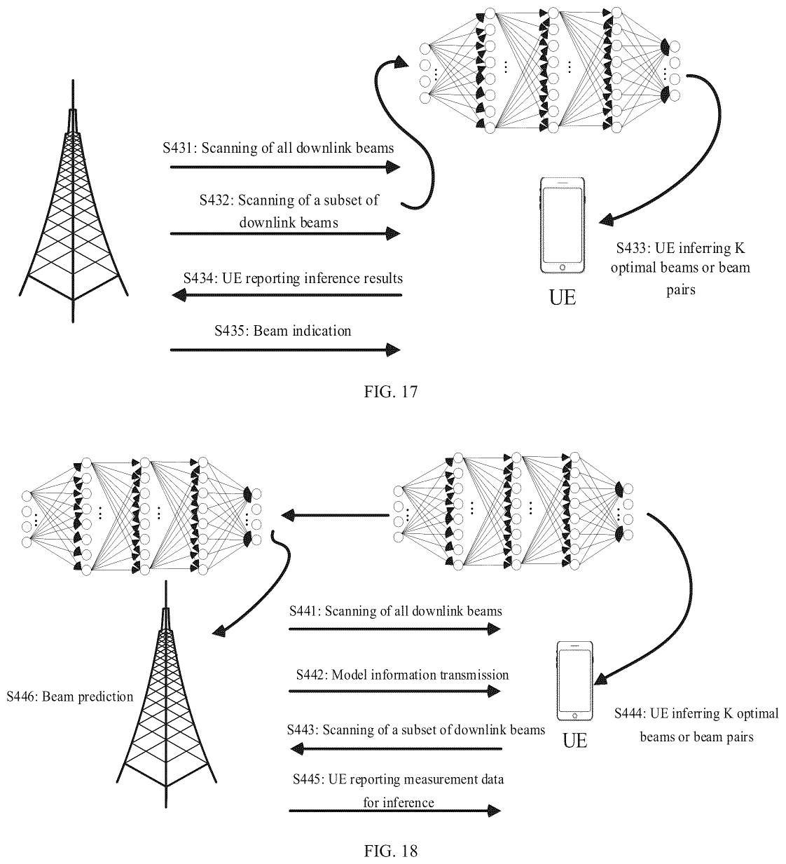

As shown in FIG. 17, the following steps are included.

In S431, the downlink beams are scanned, i.e., the P1 process is performed.

The UE determines marked information of the model based on all measurement results acquired in the beam scanning process. For example, K optimal beams or beam pairs are marked, and a training data set is constructed by using a portion of the measurement results and identification information of beams or beam pairs corresponding thereto as the input of the model, such that the model is trained.

In S432, a portion of transmitted beams (or a subset of beams) are scanned.

Correspondingly, the UE measures a portion of transmitted beams or beam pairs to acquire measurement data.

The measurement data includes measurement data corresponding to the beams or beam pairs that are partially measured.

For example, the measurement data includes identification information and measurement results corresponding to the beams or beam pairs that are partially measured, such as identification information and corresponding measurement results of M beams or beam pairs.

In S433, the UE derives K optimal beams or beam pairs and corresponding measurement results by using the target model.

In S434, the UE reports inference results to the network device.

For example, the UE transmits second indication information to the network device, where the second indication information indicates K beams or beam pairs. Reference is made to the related description of the foregoing embodiments for specific indication, which is not repeated herein. In S435, the network device indicates a beam or a beam pair.

For example, after acknowledging the K beams or beam pairs reported by the UE, the network device selects a target beam or beam pair and further indicates the target beam or beam pair to the UE. For example, the network device transmits third indication information to the UE for indicating the target beam or beam pair.

Reference is made to the indication of the first indication information for the indication of the third indication information, which is not repeated herein for brevity.

In a fifth embodiment, the terminal device trains the model and the terminal device and the network device infer the optimal beams or beam pairs.

As shown in FIG. 18, the following steps are included.

In S441, the downlink beams are scanned, i.e., the P1 process is performed.

The UE determines marked information of the model based on all measurement results acquired in the beam scanning process. For example, K optimal beams or beam pairs are marked, and a training data set is constructed by using a portion of the measurement results and identification information of beams or beam pairs corresponding thereto as the input of the model, such that the model is trained.

In S442, the UE transmits information of the trained model to the network device.

For example, model type and model parameter information is transmitted to the UE.

The UE constructs the target model by using the downloaded model type and model parameters for subsequent inference operations.

In S443, a portion of transmitted beams are scanned.

Correspondingly, the UE measures a portion of transmitted beams or beam pairs to acquire measurement data.

The measurement data includes measurement data corresponding to the beams or beam pairs that are partially measured.

For example, the measurement data includes identification information and measurement results corresponding to the beams or beam pairs that are partially measured, such as identification information and corresponding measurement results of M beams or beam pairs.

In S444, the UE infers K optimal beams or beam pairs and corresponding measurement results by using the target model.

In S445, the UE reports the measurement data for inference to the network device.

It should be understood that the present disclosure is not limited to the execution order of S444 and S445, alternatively, S445 is performed first and then S444 is performed.

In S446, the network device derives K optimal beams or beam pairs and corresponding measurement results by using the target model.

For example, after acknowledging the measurement data reported by the UE, the network device uses the measurement data as the input of the target model, for example, inputs the measurement data into the first target model and the second target model, separately, and runs the first target model and the second target model to infer indexes of K optimal beams or beam pairs and K measurement results corresponding thereto, such as K optimal L1-RSRPs.

In this case, no indication of a beam or a beam pair is performed between the network device and the UE.

In some embodiments, in the case that the inferred Tx beam is not in a set of measured Tx beams, or that the inferred beam pair is not in a set of measured beam pairs, the network device triggers the P3 process to scan by using the inferred Tx beam to determine an Rx beam corresponding to the Tx beam.

In a sixth embodiment, the terminal device trains the model and the network device infers the optimal beams or beam pairs.

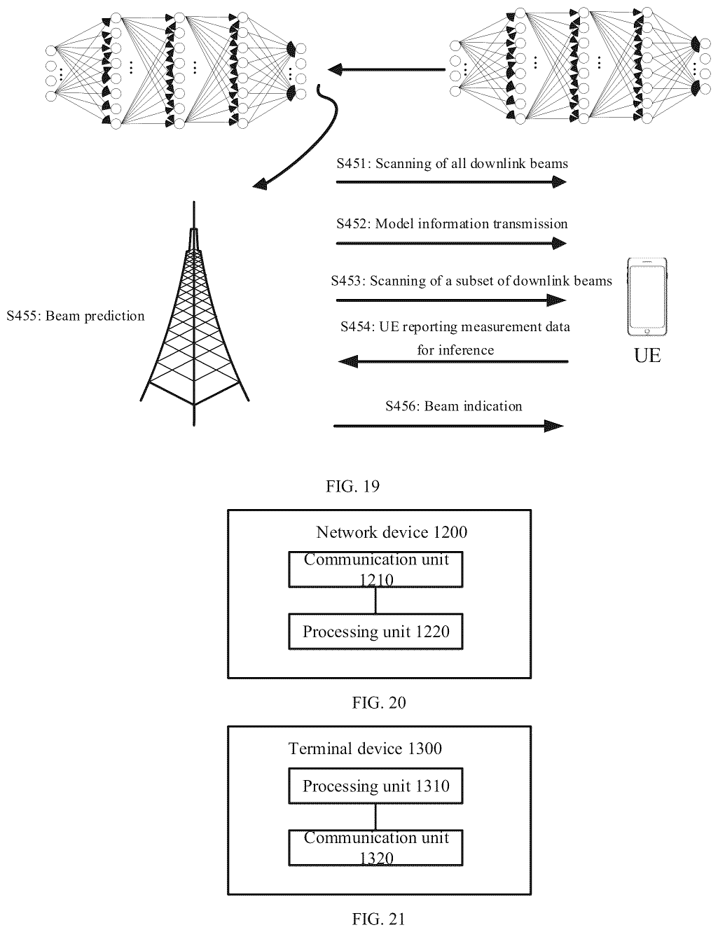

As shown in FIG. 19, the following steps are included.

In S451, the downlink beams are scanned, i.e., the P1 process is performed.

The UE determines marked information of the model based on all measurement results acquired in the beam scanning process. For example, K optimal beams or beam pairs are marked, and a training data set is constructed by using a portion of the measurement results and identification information of beams or beam pairs corresponding thereto as the input of the model, such that the model is trained.

In S452, the UE transmits information of the trained model to the network device.

For example, the model type and model parameter information is transmitted to the UE.

The UE constructs the target model by using the downloaded model type and model parameters for subsequent inference operations.

In S453, a portion of transmitted beams are scanned.

Correspondingly, the UE measures a portion of transmitted beams or beam pairs to acquire measurement data.

In S454, the UE reports the measurement data for inference to the network device.

In S455, the network device infers K optimal beams or beam pairs and corresponding measurement results by using the target model.

It should be understood that the present disclosure is not limited to the execution order of S444 and S445, alternatively, S445 is performed first and then S444 is performed.

In S456, the network device indicates the optimal beams or beam pairs to the UE.

Reference is made to the related description of S403 for specific indication, which is not repeated herein.

In summary, in the embodiments of the present disclosure, the network device only needs to scan a portion of the spatial filters, and the terminal device only needs to measure a portion of the spatial filters, such that the optimal spatial filters can be predicted by using the trained target model, which is beneficial to reducing the overhead and delay generated by downlink beam scanning.

The method embodiments of the present disclosure have been described in detail above with reference to FIG. 7 to FIG. 19, and apparatus embodiments of the present disclosure are described in detail below with reference to FIG. 20 to FIG. 26. It should be understood that the apparatus embodiments correspond to the method embodiments and that reference may be made to the method embodiments for similar descriptions.

FIG. 20 shows a schematic block diagram of a network device 1200 according to some embodiments of the present disclosure. As shown in FIG. 20, the network device 1200 includes: a communication unit 1210, configured to acquire a first data set, where the first data set includes identification information of M1 spatial filters and/or measurement results of the M1 spatial filters, M1 being a positive integer; and
a processing unit 1220, configured to input the first data set into a target model to output target information, where the target information includes identification information of K spatial filters and/or measurement results of the K spatial filters, K being a positive integer.

In some embodiments, each of the spatial filters includes a Tx spatial filter; or
each of the spatial filters includes a Tx spatial filter and an Rx spatial filter.

In some embodiments, the first data set is acquired by measuring a portion of spatial filters in a candidate spatial filter set by a terminal device, where the candidate spatial filter set includes N spatial filters, N being a positive integer.

In some embodiments, the candidate spatial filter set includes N Tx spatial filters; or
the candidate spatial filter set includes N combinations of Tx spatial filters and Rx spatial filters.

In some embodiments, the target model includes a first target model and a second target model, the first target model is configured to output the identification information of the K spatial filters, and the second target model is configured to output the measurement results of the K spatial filters.

In some embodiments, the first data set is acquired from the terminal device.

In some embodiments, the target model is acquired by training by the network device.

In some embodiments, the communication unit 1210 is further configured to: acquire a second data set.

The processing unit 1220 is further configured to: acquire model parameters of the target model by training the target model based on the second data set.

In some embodiments, the second data set includes at least one of:
identification information of M2 spatial filters, M2 being a positive integer;
measurement results of M2 spatial filters;
identification information of P optimal spatial filters, P being a positive integer; or measurement results of P optimal spatial filters.

In some embodiments, the M2 spatial filters include a portion of spatial filters in the candidate spatial filter set, and the P spatial filters are acquired by measuring all the spatial filters in the candidate spatial filter set by the terminal device.

In some embodiments, the target model is acquired by training by the terminal device.

In some embodiments, the communication unit 1210 is further configured to: receive model type and/or model parameter information of the target model from the terminal device.

In some embodiments, the communication unit 1210 is further configured to: transmit first indication information to the terminal device, where the first indication information indicates the K spatial filters.

In some embodiments, the K spatial filters are K Tx spatial filters, the first indication information indicates K transmission configuration indicator (TCI) states, and the K TCI states correspond to the K Tx spatial filters.

In some embodiments, the K spatial filters are K combinations of Tx spatial filters and Rx spatial filters, the first indication information indicates K TCI states, and the K TCI states correspond to K Tx spatial filters in the K combinations of Tx spatial filters and Rx spatial filters; or
the K spatial filters are K combinations of Tx spatial filters and Rx spatial filters, the first indication information indicates K TCI states, and the K TCI states correspond to the K combinations of Tx spatial filters and Rx spatial filters; or
the K spatial filters are K combinations of Tx spatial filters and Rx spatial filters, and the first indication information indicates identification information of the Tx spatial filter and identification information of the Rx spatial filter in each of the K combinations; or
the K spatial filters are K combinations of Tx spatial filters and Rx spatial filters, and the first indication information is the identification information of each of the K combinations.

In some embodiments, in the case that the K spatial filters belong to the M1 spatial filters, the network device transmits the first indication information to the terminal device.

In some embodiments, the K spatial filters include a first Tx spatial filter, or a combination of a first Tx spatial filter and a first Rx spatial filter; and the M1 spatial filters include M1 Tx spatial filters, or M1 combinations of Tx spatial filters and Rx spatial filters, and in the case that the first Tx spatial filter does not belong to the M1 spatial filters, the communication unit 1210 is further configured to: transmit first trigger information to the terminal device, where the first trigger information is configured to trigger the terminal device to traverse all Rx spatial filters to receive a downlink reference signal transmitted by the first Tx spatial filter to determine an optimal Rx spatial filter.

In some embodiments, the communication unit 1210 is further configured to: receive first capability information from the terminal device, where the first capability information indicates a capability of the terminal device to train the target model and/or a capability of the terminal device to predict the target information by using the target model.

In some embodiments, the first capability information includes at least one of:
information indicating whether the terminal device supports predicting the target information based on a model; a size of a training data set supported by the terminal device; a type of a model supported by the terminal device; a configuration of a model supported by the terminal device; or a type of data supported by the terminal device for predicting the target information.

In some embodiments, the communication unit 1210 is further configured to: transmit first configuration information to the terminal device based on the first capability information, where the first configuration information is used to configure the terminal device to train the target model and/or predict the target information by using the target model.

In some embodiments, the first configuration information is further used to configure a type of the target model used by the terminal device.

In some embodiments, the first configuration information is transmitted over radio resource control (RRC) signaling.

In some embodiments, the above communication unit is a communication interface or a transceiver, or an input/output interface of a communication chip or an on-chip system. The above processing unit is one or more processors.

It should be understood that the network device 1200 according to the embodiments of the present disclosure may correspond to the network device in the method embodiments of the present disclosure, and the above and other operations and/or functions of the units in the network device 1200 are separately for implementing corresponding flows of the network device in the method embodiments shown in FIG. 7 to FIG. 19, which is not repeated herein for brevity.

FIG. 21 is a schematic block diagram of a terminal device according to some embodiments of the present disclosure. The terminal device 1300 of FIG. 21 includes:
a processing unit 1310, configured to acquire a third data set, where the third data set includes identification information of M3 spatial filters and/or measurement results of the M3 spatial filters, M3 being a positive integer; and
input the third data set into a target model to output target information, where the target information includes identification information of K spatial filters and/or measurement results of the K spatial filters, K being a positive integer.

In some embodiments, each of the spatial filters includes a Tx spatial filter; or each of the spatial filters includes a Tx spatial filter and an Rx spatial filter.

In some embodiments, the third data set is acquired by measuring a portion of spatial filters in a candidate spatial filter set by the terminal device, where the candidate spatial filter set includes N spatial filters, N being a positive integer.

In some embodiments, the candidate spatial filter set includes N Tx spatial filters; or
the candidate spatial filter set includes N combinations of Tx spatial filters and Rx spatial filters.

In some embodiments, the target model includes a first target model and a second target model, the first target model is configured to output the identification information of the K spatial filters, and the second target model is configured to output the measurement results of the K spatial filters. In some embodiments, the target model is acquired by training by a network device.

In some embodiments, the terminal device further includes a communication unit 1320, configured to transmit a fourth data set to the network device, where the fourth data set is used to train the target model by the network device to acquire model parameters of the target model.

In some embodiments, the fourth data set includes at least one of:
identification information of M4 spatial filters; measurement results of M4 spatial filters; identification information of Q optimal spatial filters; or measurement results of Q optimal spatial filters, Q being a positive integer.

In some embodiments, the M4 spatial filters include a portion of spatial filters in the candidate spatial filter set, and the Q spatial filters are acquired by measuring all the spatial filters in the candidate spatial filter set by the terminal device.

In some embodiments, the terminal device further includes a communication unit 1320, configured to receive model type and/or model parameter information of the target model from the network device.

In some embodiments, the target model is acquired by training by the terminal device.

In some embodiments, the terminal device further includes a communication unit 1320, configured to acquire a fifth data set.

The processing unit 1310 is further configured to: acquire model parameters of the target model by training the target model based on the fifth data set.

In some embodiments, the fifth data set includes at least one of:
identification information of M5 spatial filters; measurement results of M5 spatial filters; identification information of X optimal spatial filters; or measurement results of X optimal spatial filters, M5 being a positive integer, and X being a positive integer.

In some embodiments, the M5 spatial filters include a portion of spatial filters in the candidate spatial filter set, and the X spatial filters are acquired by measuring all the spatial filters in the candidate spatial filter set by the terminal device.

In some embodiments, the terminal device further includes a communication unit 1320, configured to transmit model type and/or model parameters of the target model to a network device.

In some embodiments, the terminal device further includes a communication unit 1320, configured to transmit second indication information to the network device, where the second indication information indicates the K spatial filters.

In some embodiments, the K spatial filters are K Tx spatial filters, and the second indication information indicates identification information of the K Tx spatial filters.

In some embodiments, the K spatial filters are K combinations of Tx spatial filters and Rx spatial filters, and the second indication information indicates identification information of the Tx spatial filter in each of the K combinations; or
the K spatial filters are K combinations of Tx spatial filters and Rx spatial filters, and the second indication information indicates identification information of each of the K combinations; or
the K spatial filters are K combinations of Tx spatial filters and Rx spatial filters, and the second indication information indicates identification information of the Tx spatial filter and identification information of the Rx spatial filter in each of the K combinations.

In some embodiments, in the case that the K spatial filters belong to the M3 spatial filters, the terminal device transmits the second indication information to the network device.

In some embodiments, the terminal device further includes a communication unit 1320, configured to receive third indication information from the network device, where the third indication information indicates a target spatial filter determined by the network device in the K spatial filters.

In some embodiments, the target filter includes a target Tx spatial filter, the third indication information indicates at least one transmission configuration indicator (TCI) state, and the at least one TCI state corresponds to the target Tx spatial filter.

In some embodiments, the target filter includes a combination of a target Tx spatial filter and a target Rx spatial filter, the third indication information indicates at least one TCI state, and the at least one TCI state corresponds to the target Tx spatial filter in the combination; or
the target filter includes a combination of a target Tx spatial filter and a target Rx spatial filter, the third indication information indicates at least one TCI state, and the at least one TCI state corresponds to the combination; or
the target filter includes a combination of a target Tx spatial filter and a target Rx spatial filter, and the third indication information indicates identification information of the target Tx spatial filter and identification information of the target Rx spatial filter; or
the target filter includes a combination of a target Tx spatial filter and a target Rx spatial filter, and the third indication information indicates identification information of the combination.

In some embodiments, the terminal device further includes a communication unit 1320, configured to transmit fourth indication information to the network device, where the fourth indication information is used to trigger the network device to transmit a downlink reference signal by using the second spatial filter.

In some embodiments, the terminal device further includes a communication unit 1320, configured to transmit first capability information to the network device, where the first capability information indicates a capability of the terminal device to train the target model and/or a capability of the terminal device to predict the target information by using the target model.

In some embodiments, the first capability information includes at least one of:
information indicating whether the terminal device supports predicting the target information based on a model; a size of a training data set supported by the terminal device; a type of model supported by the terminal device; a configuration of model supported by the terminal device; or a type of data supported by the terminal device for predicting the target information.

In some embodiments, the terminal device further includes a communication unit 1320, configured to receive first configuration information of the network device, where the first configuration information is used to configure the terminal device to train the target model and/or predict the target information by using the target model.

In some embodiments, the first configuration information is further used to configure a type of the target model used by the terminal device.

In some embodiments, the first configuration information is transmitted over radio resource control (RRC) signaling.

In some embodiments, the above communication unit is a communication interface or a transceiver, or an input/output interface of a communication chip or an on-chip system. The above processing unit is one or more processors.

It should be understood that the terminal device 1300 according to the embodiments of the present disclosure may correspond to the terminal device in the method embodiments of the present disclosure, and the above and other operations and/or functions of the units in the terminal device 1300 are separately for implementing corresponding flows of the terminal device in the method embodiments shown in FIG. 7 to FIG. 19, which is not repeated herein for brevity.

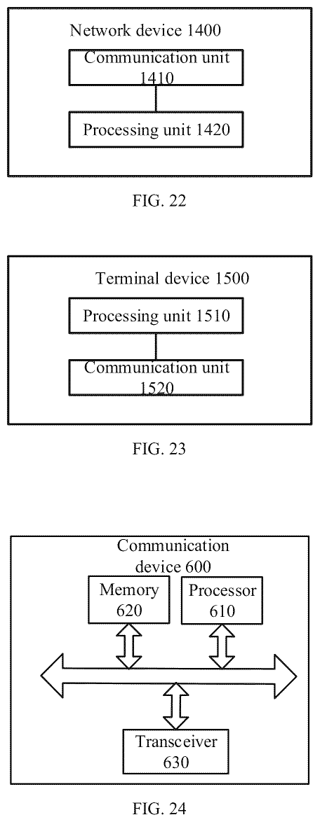

FIG. 22 shows a schematic block diagram of a network device 1400 according to some embodiments of the present disclosure. As shown in FIG. 22, the network device 1400 includes:
a communication unit 1410, configured to acquire a sixth data set, where the sixth data set includes measurement information of a plurality of spatial filters by a terminal device; and
a processing unit 1420, configured to acquire model parameters of the target model by training a target model based on the sixth data set, where the target model is used to determine a target spatial filter in the plurality of spatial filters based on measurement results of the plurality of spatial filters.

In some embodiments, the sixth data set includes at least one of:
identification information of M6 spatial filters, M6 being a positive integer;
measurement results of the M6 spatial filters;
identification information of Y optimal spatial filters, Y being a positive integer; or measurement results of the Y optimal spatial filters.

In some embodiments, the M6 spatial filters include a portion of spatial filters in a candidate spatial filter set, and the Y spatial filters are acquired by measuring all the spatial filters in the candidate spatial filter set by the terminal device.

In some embodiments, the target model includes a first target model and a second target model, the first target model is configured to output identification information of K spatial filters, and the second target model is configured to output measurement results of the K spatial filters, K being a positive integer.

In some embodiments, the communication unit 1410 is further configured to: transmit model type and/or model parameter information of the target model to the terminal device.

In some embodiments, the communication unit 1410 is further configured to: receive first capability information transmitted by the terminal device, where the first capability information indicates a capability of the terminal device to train the target model and/or a capability of the terminal device to predict the target information by using the target model.

In some embodiments, the first capability information includes at least one of:
information indicating whether the terminal device supports predicting the target information based on a model; a size of a training data set supported by the terminal device; a type of model supported by the terminal device; a configuration of model supported by the terminal device; or a type of data supported by the terminal device for predicting the target information.

In some embodiments, the communication unit 1410 is further configured to: transmit first configuration information to the terminal device, where the first configuration information is used to configure the terminal device to train the target model and/or predict the target information by using the target model.

In some embodiments, the first configuration information is further used to configure a type of the target model used by the terminal device.

In some embodiments, the first configuration information is transmitted over radio resource control (RRC) signaling. In some embodiments, the above communication unit is a communication interface or a transceiver, or an input/output interface of a communication chip or an on-chip system. The above processing unit is one or more processors.

It should be understood that the network device 1400 according to the embodiments of the present disclosure may correspond to the network device in the method embodiments of the present disclosure, and the above and other operations and/or functions of the units in the network device 1400 are separately for implementing corresponding flows of the network device in the method embodiments shown in FIG. 7 to FIG. 19, which is not repeated herein for brevity.

FIG. 23 is a schematic block diagram of a terminal device according to some embodiments of the present disclosure. The terminal device 1500 of FIG. 23 includes:
a processing unit 1510, configured to acquire a seventh data set, where the seventh data set includes measurement information of a plurality of spatial filters by the terminal device; and acquire model parameters of the target model by training a target model based on the seventh data set, where the target model is configured to determine a target spatial filter in the plurality of spatial filters based on measurement results of the plurality of spatial filters.

In some embodiments, the seventh data set includes at least one of:
identification information of M7 spatial filters, M7 being a positive integer;
measurement results of the M7 spatial filters;
identification information of Z optimal spatial filters, Z being a positive integer; or
measurement results of the Z optimal spatial filters.

In some embodiments, the M7 spatial filters include a portion of spatial filters in a candidate spatial filter set, and the Z spatial filters are acquired by measuring all the spatial filters in the candidate spatial filter set by the terminal device.

In some embodiments, the target model includes a first target model and a second target model, the first target model is configured to output identification information of K spatial filters, and the second target model is configured to output measurement results of the K spatial filters, K being a positive integer.

In some embodiments, the terminal device further includes a communication unit 1520, configured to transmit model type and/or model parameter information of the target model to a network device.

In some embodiments, the terminal device further includes a communication unit 1520, configured to transmit first capability information to the network device, where the first capability information indicates a capability of the terminal device to train the target model and/or a capability of the terminal device to predict the target information by using the target model.

In some embodiments, the first capability information includes at least one of:
information indicating whether the terminal device supports predicting the target information based on a model; a size of a training data set supported by the terminal device; a type of a model supported by the terminal device; a configuration of a model supported by the terminal device; or a type of data supported by the terminal device for predicting the target information.

In some embodiments, the terminal device further includes a communication unit 1520, configured to receive first configuration information of the network device, where the first configuration information is used to configure the terminal device to train the target model and/or predict the target information by using the target model.

In some embodiments, the first configuration information is further used to configure a type of the target model used by the terminal device.

In some embodiments, the first configuration information is transmitted over radio resource control (RRC) signaling.

In some embodiments, the above communication unit is a communication interface or a transceiver, or an input/output interface of a communication chip or an on-chip system. The above processing unit is one or more processors.

It should be understood that the terminal device 1500 according to the embodiments of the present disclosure may correspond to the terminal device in the method embodiments of the present disclosure, and the above and other operations and/or functions of the units in the terminal device 1500 are separately for implementing corresponding flows of the terminal device in the method embodiments shown in FIG. 7 to FIG. 19, which is not repeated herein for brevity.

FIG. 24 is a schematic structural diagram of a communication device 600 according to some embodiments of the present disclosure. The communication device 600 shown in FIG. 24 includes a processor 610. The processor 610 loads and runs one or more computer programs from a memory to implement the methods in the embodiments of the present disclosure.

In some embodiments, as shown in FIG. 24, the communication device 600 further includes a memory 620. The processor 610 loads and runs the one or more computer programs from the memory 620 to perform the methods in the embodiments of the present disclosure.

The memory 620 is a separate device independent from the processor 610 or is integrated within the processor 610.

In some embodiments, as shown in FIG. 24, the communication device 600 further includes a transceiver 630. The processor 610 controls the transceiver 630 to communicate with other devices, specifically, to transmit information or data to other devices, or to receive information or data transmitted by other devices.

The transceiver 630 includes a transmitter and a receiver. The transceiver 630 further includes one or more antennas.

In some embodiments, the communication device 600 is specifically the network device of the embodiments of the present disclosure, and the communication device 600 implements corresponding flows implemented by the network device in various methods of the embodiments of the present disclosure, which is not repeated herein for brevity.

In some embodiments, the communication device 600 is specifically the mobile terminal/terminal device of the embodiments of the present disclosure, and the communication device 600 implements corresponding flows implemented by the mobile terminal/terminal device in various methods of the embodiments of the present disclosure, which is not repeated herein for brevity.

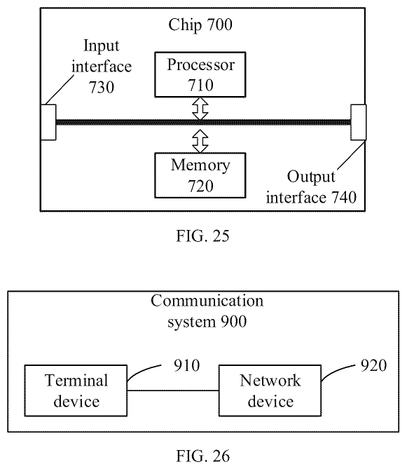

FIG. 25 is a schematic structural diagram of a chip according to some embodiments of the present disclosure. The chip 700 shown in FIG. 25 includes a processor 710. The processor 710 loads and runs one or more computer programs from a memory to implement the methods in the embodiments of the present disclosure.

In some embodiments, as shown in FIG. 25, the chip 700 further includes a memory 720. The processor 710 loads and runs the one or more computer programs from the memory 720 to implement the methods in the embodiments of the present disclosure.

The memory 720 is a separate device independent from the processor 710 or is integrated within the processor 710.

In some embodiments, the chip 700 further includes an input interface 730. The processor 710 controls the input interface 730 to communicate with other devices or chips, specifically, to acquire information or data transmitted by other devices or chips.

In some embodiments, the chip 700 further includes an output interface 740. The processor 710 controls the output interface 740 to communicate with other devices or chips, specifically, to output information or data to other devices or chips.

In some embodiments, the chip is applicable to the network device in the embodiments of the present disclosure, and the chip implements corresponding flows implemented by the network device in various methods of the embodiments of the present disclosure, which is not repeated herein for brevity.

In some embodiments, the chip is applicable to the mobile terminal/terminal device in the embodiments of the present disclosure, and the chip implements corresponding flows implemented by the mobile terminal/terminal device in various methods of the embodiments of the present disclosure, which is not repeated herein for brevity.

It should be understood that the chip mentioned in the embodiments of the present disclosure may also be referred to as system-on-chip, system chip, chip system, or on-chip system.

FIG. 26 is a schematic block diagram of a communication system 900 according to some embodiments of the present disclosure. As shown in FIG. 26, the communication system 900 includes a terminal device 910 and a network device 920.

The terminal device 910 is configured to implement corresponding functions implemented by the terminal device in the above methods, and the network device 920 is configured to implement corresponding functions implemented by the network device in the above methods, which is not repeated herein for brevity.

It should be understood that the processor in the embodiments of the present disclosure is an integrated circuit chip capable of signal processing. During the implementation, each process in the foregoing method embodiments is performed by an integrated logic circuit of hardware in the processor or by using an instruction in a form of software. The processor is a general-purpose processor, a digital signal processor (DSP), an application-specific integrated circuit (ASIC), a field programmable gate array (FPGA) or another programmable logic device, a discrete gate or transistor logic device, or a discrete hardware component. The processor implements or executes the methods, processes, and logical block diagrams disclosed in the embodiments of the present disclosure. The general-purpose processor is a microprocessor, or the processor is any conventional processor or the like. The processes of the methods disclosed with reference to the embodiments of the present disclosure are directly performed by a hardware decoding processor, or performed by a combination of hardware and software modules in the decoding processor. The software module is located in a mature storage medium in the art, such as a random access memory (RAM), a flash memory, a read-only memory (ROM), a programmable ROM (PROM), an electrically erasable programmable memory, or a register. The storage medium is located in a memory. The processor reads information in the memory, and completes the processes of the foregoing methods in combination with hardware in the processor.

It can be understood that the memory in the embodiments of the present disclosure is a transitory memory or a non-transitory memory, or includes both a transitory memory and a non-transitory memory. The non-transitory memory is a ROM, a PROM, an erasable PROM (EPROM), an electrically EPROM (EEPROM), or a flash memory. The transitory memory is a RAM, used as an external cache. Through illustrative rather than restrictive description, RAMs of many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM). It should be noted that the memory involved in the systems and methods described in this specification includes, but is not limited to, these memories and a memory of any other suitable type.

It should be understood that the foregoing description of the memory is exemplary but not limiting. For example, the memory in the embodiments of the present disclosure is alternatively an SRAM, a DRAM, an SDRAM, a DDR SDRAM, an ESDRAM, an SLDRAM, or a DRRAM. In other words, the memory in the embodiments of the present disclosure includes, but not be limited to, these and any other suitable types of memory.

The embodiments of the present disclosure further provide a computer-readable storage medium configured to store one or more computer programs.

Optionally, the computer-readable storage medium is applied to the network device in the embodiments of the present disclosure. The one or more computer programs, when loaded and run by a computer, cause the computer to execute a corresponding process implemented by the network device in each method in the embodiments of the present disclosure. For brevity, details are not described herein again.

Optionally, the computer-readable storage medium is applied to the mobile terminal/terminal device in the embodiments of the present disclosure. The one or more computer programs, when loaded and run by a computer, cause the computer to execute a corresponding process implemented by the mobile terminal/terminal device in each method in the embodiments of the present disclosure. For brevity, details are not described herein again.

The embodiments of the present disclosure further provide a computer program product, including one or more computer program instructions.

Optionally, the computer program product is applied to the network device in the embodiments of the present disclosure. The one or more computer program instructions, when called and executed by a computer, cause the computer to execute a corresponding process implemented by the network device in each method in the embodiments of the present disclosure. For brevity, details are not described herein again.

Optionally, the computer program product is applied to the mobile terminal/terminal device in the embodiments of the present disclosure. The one or more computer program instructions, when loaded and executed by a computer, cause the computer to execute a corresponding process implemented by the mobile terminal/terminal device in each method in the embodiments of the present disclosure. For brevity, details are not described herein again.

The embodiments of the present disclosure further provide a computer program.

Optionally, the computer program is applied to the network device in the embodiments of the present disclosure. The computer program, when loaded and run by a computer, causes the computer to execute a corresponding process implemented by the network device in each method in the embodiments of the present disclosure. For brevity, details are not described herein again.

Optionally, the computer program is applied to the mobile terminal/terminal device in the embodiments of the present disclosure. The computer program, when loaded and run by a computer, causes the computer to execute a corresponding process implemented by the mobile terminal/terminal device in each method in the embodiments of the present disclosure. For brevity, details are not described herein again.

A person of ordinary skill in the art is aware that, in combination with the examples described in the embodiments disclosed in this specification, units and algorithm steps are implemented by electronic hardware or a combination of computer software and electronic hardware. Whether the functions are performed by hardware or software depends on particular applications and design constraints of the technical solutions. A skilled person may use different methods to implement the described functions for each particular application, but it should not be considered that the implementation goes beyond the scope of the present disclosure.

A person skilled in the art can clearly understand that for convenience and brevity of description, reference is made to corresponding processes in the foregoing method embodiments for specific working processes of the foregoing systems, apparatuses, and units. Details are not described herein again.

In the several embodiments provided in the present disclosure, it should be understood that the disclosed systems, apparatuses, and methods may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented over some interfaces. The indirect couplings or communication connections between the apparatuses or units may be implemented in electrical, mechanical, or other forms

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, each of the units may exist alone physically, or two or more units are integrated into one unit.

If implemented in a form of a software functional unit and sold or used as a standalone product, functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium, and includes instructions for instructing a computer device (which may be a personal computer, a server, a network device, or the like) to perform all or some of the steps of the methods described in the embodiments of the present disclosure. The storage medium includes any medium capable of storing program code, such as a Universal Serial Bus (USB) flash disk, a mobile hard disk, a ROM, a RAM, a magnetic disk, or an optical disk.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

1. A method for wireless communication, applicable to a network device, the method comprising:
acquiring a first data set, wherein the first data set comprises at least one of identification information of M1 spatial filters or measurement results of the M1 spatial filters, M1 being a positive integer; and
inputting the first data set into a target model to output target information, wherein the target information comprises at least one of identification information of K spatial filters or measurement results of the K spatial filters, K being a positive integer.

2. The method according to claim 1, wherein:
each of the spatial filters comprises a transmission (Tx) spatial filter; or
each of the spatial filters comprises a Tx spatial filter and a reception (Rx) spatial filter.

3. The method according to claim 1, wherein the first data set is acquired by measuring a portion of spatial filters in a candidate spatial filter set by a terminal device, wherein the candidate spatial filter set comprises N spatial filters, N being a positive integer.

4. The method according to claim 3, wherein:
the candidate spatial filter set comprises N Tx spatial filters; or
the candidate spatial filter set comprises N combinations of Tx spatial filters and Rx spatial filters.

5. The method according to claim 1, wherein the target model is acquired by training by the network device.

6. The method according to claim 5, further comprising:
acquiring a second data set; and
acquiring model parameters of the target model by training the target model based on the second data set.

7. The method according to claim 6, wherein the second data set comprises at least one of:
identification information of M2 spatial filters, M2 being a positive integer;
measurement results of M2 spatial filters;
identification information of P optimal spatial filters, P being a positive integer; or
measurement results of P optimal spatial filters.

8. The method according to claim 7, wherein the M2 spatial filters comprise a portion of spatial filters in a candidate spatial filter set, and wherein the P spatial filters are acquired by measuring all the spatial filters in the candidate spatial filter set by a terminal device.

9. The method according to claim 1, wherein the K spatial filters comprise a first Tx spatial filter, or a combination of a first Tx spatial filter and a first Rx spatial filter; and the M1 spatial filters comprise M1 Tx spatial filters, or M1 combinations of Tx spatial filters and Rx spatial filters; and wherein in a case that the first Tx spatial filter does not belong to the M1 spatial filters, the method further comprises:
transmitting first trigger information to a terminal device, wherein the first trigger information is configured to trigger the terminal device to traverse all Rx spatial filters to receive a downlink reference signal transmitted by the first Tx spatial filter to determine an optimal Rx spatial filter.

10. The method according to claim 1, further comprising:
receiving first capability information from a terminal device, wherein the first capability information indicates at least one of a capability of the terminal device to train the target model or a capability of the terminal device to predict the target information by using the target model.

11. The method according to claim 10, wherein the first capability information comprises at least one of:
information indicating whether the terminal device supports predicting the target information based on a model;
a size of a training data set supported by the terminal device;
a type of a model supported by the terminal device;
a configuration of a model supported by the terminal device; or
a type of data supported by the terminal device for predicting the target information.

12. A method for wireless communication, applicable to a terminal device, the method comprising:
acquiring a third data set, wherein the third data set comprises at least one of identification information of M3 spatial filters or measurement results of the M3 spatial filters, M3 being a positive integer; and
inputting the third data set into a target model to output target information, wherein the target information comprises at least one of identification information of K spatial filters or measurement results of the K spatial filters, K being a positive integer.

13. The method according to claim 12, wherein:
each of the spatial filter comprises a Tx spatial filter; or
each of the spatial filter comprises a Tx spatial filter and an Rx spatial filter.

14. The method according to claim 12, wherein the third data set is acquired by measuring a portion of spatial filters in a candidate spatial filter set by the terminal device, wherein the candidate spatial filter set comprises N spatial filters, N being a positive integer.

15. The method according to claim 14, wherein:
the candidate spatial filter set comprises N Tx spatial filters; or
the candidate spatial filter set comprises N combinations of Tx spatial filters and Rx spatial filters.

16. A method for wireless communication, applicable to a network device, the method comprising:
acquiring a sixth data set, wherein the sixth data set comprises measurement information of a plurality of spatial filters by a terminal device; and
acquiring model parameters of a target model by training the target model based on the sixth data set, wherein the target model is configured to determine a target spatial filter in the plurality of spatial filters based on measurement results of the plurality of spatial filters.

17. A network device, comprising:
a processor and a memory configured to store one or more computer programs, which when executed by the processor, causes the processor to perform the method of claim 1.

18. A network device, comprising:
a processor and a memory configured to store one or more computer programs, which when executed by the processor, causes the processor to perform the method of claim 16.

19. A terminal device, comprising:
a processor and a memory configured to store one or more computer programs, which when executed by the processor, causes the processor to perform the method of claim 12.

20. The terminal device according to claim 19, wherein:
each of the spatial filter comprises a Tx spatial filter; or
each of the spatial filter comprises a Tx spatial filter and an Rx spatial filter.
